(19) United States
(12) Patent Application Publication
(10) Pub. No.: US 2023/0306216 A1
(43) Pub. Date: Sep. 28, 2023

(54) METHOD AND DEVICE FOR EVALUATING MATRIX CODES

(71) Applicant: TECHNISCHE UNIVERSITÄT DORTMUND, DORTMUND (DE)

(72) Inventors: JIANSHUANG XU, HOLZWICKEDE (DE); CHRISTIAN BRAUERS, PADERBORN (DE); RUEDIGER KAYS, LUEDINGHAUSEN (DE); JOHANNES KLEIN, HOLZWICKEDE (DE)

(73) Assignee: TECHNISCHE UNIVERSITÄT DORTMUND, DORTMUND (DE)

(21) Appl. No.: 18/018,583

(22) PCT Filed: Jul. 22, 2021
(86) PCT No.: PCT/EP2021/070576

§ 371 Date: Jan. 30, 2023

(30) Foreign Application Priority Data
Jul. 31, 2020 (DE) 10 2020 120 285.7
Nov. 23, 2020 (DE) 10 2020 130 929.5

(51) Int. Cl. G06K 7/14

(52) U.S. Cl. CPC G06K 7/1417; G06K 7/1447

(57) ABSTRACT

A method, a software application, and a reader for evaluating a matrix code in an image, in which the patterns of the individual symbol rows are reconstructed, and scanning values are determined at the intersections of the symbol row patterns. Firstly, the approximate position of each of the symbols along the symbol rows in the direction of a first dimension of the image is determined successively, with the determined pixel positions being used as the position of the symbols in the direction of the first dimension, and subsequently the patterns of the individual symbol rows along the other dimension of the complete image are determined successively. These two steps are then repeated for the other dimension. The scanning points are determined on the basis of the properties of the data modulation taking into consideration the channel distortions. A decorrelation of the scanned symbols reduceS the local inter-symbol interferences.

### CROSS REFERENCE TO PRIOR APPLICATIONS

This application is a U.S. National Phase application under 35 U.S.C. § 371 of International Application No. PCT/EP2021/070576, filed on Jul. 22, 2021 and which claims benefit to German Patent Application No. 10 2020 120 285.7, filed on Jul. 31, 2020, and to German Patent Application No. 10 2020 130 929.5, filed on Nov. 23, 2020. The International Application was published in German on Feb. 3, 2022 as WO 2022/023175 A1 under PCT Article 21(2).

### FIELD

The present invention relates to a method and a device for evaluating two-dimensional matrix codes within image data of a starting image which is formed by a camera recording or was obtained from camera recordings.

### BACKGROUND

The term matrix code, also called 2D barcode, denotes two-dimensional data grids in which the data are coded in symbol series arranged in rows and columns. The symbols usually have a block form, but other forms are also possible, such as e.g. circles. Known examples of matrix codes are so-called QR codes, see FIG. 3a, and data matrix codes, see FIG. 3b.

FIG. 1 shows the general two-dimensional structure of a matrix code 1 for rendering on a digital display, e.g., a screen. Each symbol, hereinafter (without restriction to any symbol form) also called data block 3, is assigned a unique position in the matrix code, the position being defined by a specific column xₙ and a specific row yₙ, wherein the row and the column can be indicated by a corresponding index. The rows here extend in the direction of a first dimension x and the columns in the direction of the other or second dimension y. The total number of rows is N_{y} and the total number of columns is Nₓ.

A data block 3 consists of one or a plurality of data elements 4 of identical content, which typically, in the case of a matrix code printed onto a physical carrier (paper), are generated from the image dots of the print or, in the case of rendering on a digital display (screen), are generated from the pixels of the screen. FIG. 1 illustrates purely by way of example that a data block 3 is formed from 3×3 pixels 4. However, there may also be more or fewer pixels 4. Furthermore, a data block 3 need not necessarily be square or need not have the same number of data elements in the direction of both dimensions x, y.

The data can be coded e.g., by intensity variation of the data blocks 3. In the case of QR codes and data matrix codes, only two brightness values are used, namely bright and dark, and so the data are binary encoded. A bright data block and a dark data block can each be understood as a separate symbol, and so a data block can embody two different symbols or, in more precise terms, can have symbol values. In this case, a dark data block can e.g., represent a logic ‘0’ and a bright data block a logic ‘1’, so that the symbol values in the case of such coding correspond to brightness information. However, the coding can also be inverted.

Matrix codes can have an arbitrary size or an arbitrary number of rows and columns, in principle, and need not necessarily be square. Often only a small amount of data is coded in matrix codes, e.g., a link to a web page on the Internet, and so the code size and the decoding complexity are comparatively low. In this regard, the matrix code by means of a brief scan using a reader, e.g., a conventional smartphone with camera, a small amount of information can be downloaded from the Internet without registration. Owing to the universality of this technology, it is used in diverse ways, e.g., for the labelling of goods, for the interlinking of web pages in advertising media, for digital tickets, remittance slips for invoices etc.

On account of the tremendously rapid development of information technology in recent decades, the transfer of larger amounts of data by way of a matrix code is desirable in more and more application scenarios. In this regard, more comprehensive data, e.g., a rail ticket with extensive customer information, an audio file or even an image should also be able to be transferred into the reader by means of a matrix code. The use of codes having a low information density, i.e., having a small number of data blocks or symbols, is no longer sufficient for this purpose. The trend is therefore toward matrix codes having a higher number of data blocks/symbols, which at the same time must become increasingly smaller on account of the restricted dimensions of the code, e.g., as a result of technical conditions such as screen size or as a result of general conditions predefined by a user.

For optionally transferring varying amounts of data, e.g., the QR code offers different versions (version 1 to version 40) which define different code dimensions. A QR code of version 40 consists of 177×177 data blocks (Nₓ=177, N_{y}=177) and can encode up to 2953 payload bytes. In comparison therewith, a data matrix code can only have a maximum of 144×144 data blocks (Nₓ=144, N_{y}=144). For even more data capacity, A. Grillo, A. Lentini, M. Querini, and G. F. Italiano, High capacity colored two dimensional codes, in Proceedings of the International Multiconference on Computer Science and Information Technology. IEEE, 2010, pp. 709-716″, have described so-called HCC2D codes and M. E. V. Melgar, M. C. Farias, F. de Banos Vidal, and A. Zaghetto, A high density colored 2d-barcode: Cqr code-9, in 2016 29^{th} SIBGRAPI Conference on Graphics, Patterns and Images (SIBGRAPI). IEEE, 2016, pp. 329-334, have described so-called CQR codes, which are based on the structure of the QR codes and utilize color information as well.

The constantly increasing display and camera resolutions also offer further potential for increasing the volume of data with the use of modern hardware. In contrast to the traditional way of printing matrix codes on analog materials (paper, cardboard, film, etc.) or embedding them just in a corner of a digital display, new concepts are being developed which utilize the entire display region for transfer purposes. In this case, each pixel of the display can theoretically represent a data block, which in the case of a full HD display results in a massive matrix code having 1920×1080 data blocks/symbols. In the practical implementation, however, often a plurality of pixels, for example, 2×2, 3×3, 4×4, 10×10 pixels, etc., if appropriate including non-square pixel groupings, must be used for forming a data block on the display in order to provide the robustness and flexibility of the transfer.

In systems such as COBRA (T. Hao, R. Zhou, and G. Xing, Cobra: color barcode streaming for smartphone systems, in Proceedings of the 10th international conference on Mobile systems, applications, and services, 2012, pp. 85-98), LightSync (W. Hu, H. Gu, and Q. Pu, Lightsync: Unsynchronized visual communication over screen-camera links, in Proceedings of the 19th annual international conference on Mobile computing & networking, 2013, pp. 15-26) and RainBar (Q. Wang, M. Zhou, K. Ren, T. Lei, J. Li, and Z. Wang, Rain bar: Robust application-driven visual communication using color barcodes, in 2015 IEEE 35th International Conference on Distributed Computing Systems. IEEE, 2015, pp. 537-546), data block sizes of approximately 10×10 pixels can be used for virtually error-free transfer under favorable conditions. Since the time dimension is here also utilized, these concepts are suitable for downloading large files, such as e.g., image and audio files, or even for data streaming.

Further concepts having attractive features such as invisible data modulation have also been developed in recent years. A transfer system with a modulation concept for optical free-space transfer is described, for example, in the German patent application DE 102014008405 A1. The patent application DE 102018124339 A1 additionally describes a method for temporal synchronization for this transfer system. This system achieves robust data transfer using modern smartphones with a data block size of 4×4 full HD pixels. With an industrial camera and an OLED display, it is even possible to achieve a block size of 3×3 UHD pixels (corresponding to 1.5×1.5 full HD pixels), which corresponds to a high-density matrix code of 1280×720 data blocks in each data frame (image of an image sequence to be displayed on the display). Given an image refresh rate of 60 Hz on the transmitter display, this yields a data rate of 55 Mbit/s.

In practice, the matrix codes are read with the aid of mobile readers having built-in cameras, such as e.g., a specific reader or a smartphone. In this case, the matrix code 1 is typically not ideally projected onto the entire area of the camera sensor. As illustrated in FIG. 2, the image representation of the code 1, having undergone perspective distortion, is instead situated in a partial region 6 of the camera recording 5. Said partial region 6, hereinafter also called code area, has a trapezoidal shape in FIG. 2, as a result of which the data reconstruction is made more difficult.

This is because reconstructing the data of the matrix code 1 in the camera recording requires sampling the individual data blocks 3 or symbols. It is only after successful sampling that the data blocks can again be demodulated into a bit stream (conversion of the symbols into values) and decoded (conversion of the values into the originally coded data), if appropriate with the aid of redundancies contained in the matrix code. It is ideally sufficient for a simple linear sampling grid 8 composed of sampling points 9 to be placed perspectively on the code area 6, as is illustrated in FIG. 2a. However, there are a number of problems in doing this:
Inaccuracy of the localization: The code area 6, i.e., the matrix code 1 within the camera recording 5, is often localized with a specific pattern within the code 1 such as the finder pattern 2a in three corners of a QR code (compare FIG. 3a). However, this kind of finding has a limited accuracy and typically results in a deviation of a few pixels between the position of the individual data blocks and their actual position in the camera recording. This deviation is automatically transferred to the sampling grid 8 based thereon. Although this is noncritical in the case of matrix codes having only a small number of data blocks, it rapidly causes incorrect sampling in the case of codes having higher information density by virtue of neighboring blocks being erroneously evaluated. Therefore, in many concepts of two-dimensional matrix codes, the entire code area 6 is divided into a plurality of uniform partial regions by alignment patterns 2b and the sampling points are determined with the aid of these alignment patterns 2b. However, this method often exhibits instability under unfavorable conditions and can actually limit the deviation of the sampling points 9 from the actual block center only to a certain degree.
Camera lens distortion: The lenses of the digital cameras of devices for reading matrix codes often cause severe distortion of the image so that what is in reality a straight line is projected onto an arcuate curve in the camera recording (compare FIG. 14). This phenomenon known as “distortion” is typically location-dependent, i.e., the degree of distortion is dependent on the position of the object in the camera recording. In this regard, the central region of the recording is generally distorted significantly less than the edge regions thereof. The influence of lens distortion can therefore be disregarded in the case of matrix codes having a small number of data blocks, which are often only recorded by the central sensor region of the camera. However, high-density matrix codes require a larger sensor area since, for successful transfer of the matrix code from the paper or the display, each data block or each symbol must be projected onto at least one image pixel of the camera sensor. In this case, the lens distortion intensifies the inaccuracy of a linear sampling grid 8.
A camera lens also has a low-pass filter characteristic, as a result of which an incident light beam on the image sensor is typically spread to a circle. This has the effect that the brightness and/or color information of a data block extends into the neighboring data blocks and is superimposed on the brightness and/or color information thereof, and this takes place vice versa. This undesirable phenomenon, known as crosstalk of symbol information into neighboring symbols, is also referred to as “spatial intersymbol interference” (spatial ISI). A symbol error is caused if e.g., a dark data block (representing e.g., a logic ‘0’) is erroneously interpreted as a bright data block (representing e.g., a logic ‘1’) on account of the spatial ISI. Since high-density matrix codes normally have a small data block size in the recording on account of the naturally finite resolution of the camera sensor, i.e., a data block 3 of the matrix code 1 is projected onto a small number of image pixels, or even just one image pixel, of the camera sensor, the spatial ISI is here particularly critical.

The literature describes a large number of methods for sampling matrix codes, the sampling points being detected almost exclusively with the aid of specific patterns. In the case of QR codes, alignment patterns are embedded at regular intervals. The number of alignment patterns is dependent on the version of the QR code. They provide for subdividing the entire code into a plurality of partial regions of a few data blocks. After the alignment patterns 2b have been detected, a respective sampling grid can subsequently be defined in each partial region, thus resulting in a reduction of the inaccuracy on account of the small number of data blocks. A data matrix code is also divided into partial regions by alignment bars 2c. In this case, in each partial region on the upper and right image edges timing patterns 2d are used for the determination of the sampling points. A timing pattern 2d consists of a strip of data blocks whose brightness alternates between bright and dark. Detection of each block of the timing pattern results in the definition of a respective straight line parallel to the corresponding localization pattern (referred to as finder pattern). The intersection points of all the straight lines determine the final sampling points.

This pattern-based method is also implemented largely in an adapted form in the recently developed concepts for high-density matrix codes. An RDCode, described in A. Wang, S. Ma, C. Hu, J. Huai, C. Peng, and G. Shen, Enhancing reliability to boost the throughput over screen-camera links, in Proceedings of the 20th annual international conference on Mobile computing and networking, 2014, pp. 41-52, uses the so-called distributed locators in order to subdivide the code into uniform regions and to recognize the sampling points in a manner similar to that in the case of the QR code. In the case of COBRA and LightSync, a timing pattern is embedded at each image edge and the sampling points, similarly to the data matrix code, are determined by connecting the corresponding blocks of the timing pattern from the two parallel edge pairs. In the case of InFrame++, described in A. Wang, Z. Li, C. Peng, G. Shen, G. Fang, and B. Zeng, InFrame++ achieves simultaneous screen-human viewing and hidden screen-camera communication, in Proceedings of the 13th Annual International Conference on Mobile Systems, Applications and Services, 2015, pp. 181-195, a similar method is developed, the timing patterns having a more complex structure. Correlation with the predefined pattern structure here makes it possible to facilitate the detection at low contrast. The channel distortions such as e.g., lens distortion are also here taken into account by carrying out a correction of the coordinates of sampling points according to the detected patterns. RainBar adds additional timing patterns in the center of the code region in order to reduce the inaccuracy of the sampling points caused by lens distortion. In the case of PiCode, described in C. Chen, W. Huang, B. Zhou, C. Liu, and W. H. Mow, Picode: A new picture-embedding 2d barcode, IEEE Transactions on Image Processing, vol. 25, no. 8, pp. 3444-3458, 2016, use is likewise made of the concept with a timing pattern, an improvement in the accuracy being attained by means of a matched filter.

### SUMMARY

Against this background, it is an object of the present invention to ascertain a sampling grid which enables a reliable, correct sampling of matrix codes.

In an embodiment, the present invention provides a method for evaluating a two-dimensional matrix code comprising symbol series which are arranged in rows and columns. The two-dimensional matrix code is set forth in a complete image comprising pixel series which are arranged in rows and columns. Individual symbol series profiles are reconstructed on a basis of the complete image. Samples are ascertained at intersection points of the individual symbol series profiles. The method includes four steps. The first step includes ascertaining an approximate position of symbols along the symbol series in a direction of a first dimension of the complete image successively for a number q of groups of k_{P} mutually adjacent pixel series in the direction of the first dimension via a procedure in which, for each of the number q of the groups of kₚ, an even function is applied to DC component-free signal profiles along the individual pixel series in the direction of the first dimension so as to process the DC component-free signal profiles, and then summing the DC component-free signal profiles which have been processed to form a summation signal, wherein the summation signal is subjected to a bandpass filtering and pixel positions are ascertained at which a bandpass-filtered summation signal has in each case a local maximum. The first step alternatively includes ascertaining an approximate position of symbols along the symbol series in a direction of a first dimension of the complete image successively for a number q of pixel series distributed over the complete image in the direction of the first dimension by a procedure in which, an even function is applied to a DC component-free complete image so as to process the DC component-free complete image, filtering the DC component-free complete image which has been processed in a direction of a second dimension with a transposed vector of ones having k_{P} elements, and then subjecting the DC component-free complete image which has been processed and filtered to a bandpass filtering in the direction of the first dimension so as to ascertain, in a q pixel series, those pixel positions at which a bandpass-filtered signal along a respective pixel series has in each case a local maximum. The ascertained pixel positions are used as a position of the symbols in the direction of the first dimension. The second step includes ascertaining the individual symbol series profiles along an other dimension of the complete image successively via a procedure in which a search band is defined for each of the individual symbol series along the other dimension and ascertained symbol positions which lie within a corresponding search band are firstly ascertained, wherein for each of the individual symbol series profiles along the other dimension, a mathematical model of a curve describing the corresponding profile is fitted so that the curve interpolates and smooths the ascertained symbol positions within the respective corresponding search band. The third step includes repeating the first step for the other dimension in order to ascertain an approximate position of the symbols along the symbol series in a direction of the other dimension. The fourth step includes repeating the second step for the first dimension in order to ascertain the individual symbol series profiles along the first dimension of the complete image.

### BRIEF DESCRIPTION OF THE DRAWINGS

The present invention is described in greater detail below on the basis of embodiments and of the drawings in which:

FIG. 1 shows the general two-dimensional structure of a matrix code 1 for rendering on a digital display, e.g., a screen;

FIG. 2 shows that the image representation of the code 1, having undergone perspective distortion, being situated in a partial region 6 of the camera recording 5;

FIG. 2a shows a simple linear sampling grid 8 composed of sampling points 9 which are placed perspectively on the code area 6;

FIG. 3a shows a QR codes;

FIG. 3b shows a data matrix code;

FIG. 4 shows the general sequence of the method of the present invention including, in step 900, where the samples are subjected to postprocessing and the effect of crosstalk, i.e., the intersymbol interference, is compensated for;

FIG. 5 shows the method steps which are or which can be part of a preprocessing applied to a starting image 1b;

FIG. 6 shows the determining of the profiles of the symbol series and also a sampling grid for sampling the matrix code from the symbol series profiles;

FIG. 7 shows the individual steps when determining the center of the symbol positions along the rows of the matrix code 1 in accordance with step 300;

FIG. 7a shows an alternative to the course of the method in FIG. 7 where a complete image 12 is processed in its entirety, instead of the windowed processing;

FIG. 8 shows the individual steps in accordance with step 400;

FIG. 9 shows the method sequence 500 for the coarse detection of the center of the symbol positions along the second dimension of the matrix code;

FIG. 9a shows an alternative method sequence for the coarse detection of the center of the symbol positions along the second dimension of the matrix code;

FIG. 10 concretizes the individual method steps of method section 600;

FIG. 11 shows the individual method steps of method section 800 where a decision algorithm is represented by the block 810;

FIG. 12 shows the method steps for, after sampling, the spatial intersymbol interference is compensated for by equalization filtering being carried out (equalizer) on the basis of the correlation properties of the sampled signal;

FIG. 13 shows a matrix code 1 composed of Nₓ=80 columns 15 and N_{y}=45 rows 14;

FIG. 14 shows exemplary starting image 1b having severe distortion so that what is in reality a straight line is projected onto an arcuate curve in the camera recording;

FIG. 15 show the matrix code 1 or the code area 6 after the homographic projection thereof onto the complete image where an offset of the corners is absent;

FIG. 16 show the matrix code 1 or the code area 6 after the homographic projection thereof onto the complete image where an offset of the corners is taken into account;

FIG. 17 shows an enlargement of the top left corner 6a of the code area 6 of FIG. 16;

FIG. 18 shows the low-pass-filtered complete image 12 after having been subsequently subjected to low-pass filtering;

FIG. 19 shows four image signal profiles Si(j) of the first group qn=1 where j=1 . . . 1920, specifically for the pixel rows i=12, 36, 60 and 84;

FIG. 20 shows the squared DC component-free image signal profiles (Sᵢ−S̅ₗ)² for the four pixel rows 12, 36, 60 and 84;

FIG. 21 shows step 340 which involves summing the k_{P} squared image signal profiles (Sᵢ−S̅ₗ)² to form a summation signal Σ(Sᵢ−S̅ₗ)² of the group qₙ;

FIG. 22 shows the bandpass-filtered summation signal f_{B};

FIG. 23 shows the complete image 12 with point profile 17 in the row direction;

FIG. 24 shows the point profile 17 in the row direction for the next window 13 or the second group q₂;

FIG. 25 shows the point profile 17 in the complete image 12 in the row direction for all windows 13 or all 9 groups;

FIG. 26 shows at the top the complete image 12 in accordance with FIG. 25 with a depicted column window 18 in the horizontal image center, which window is illustrated in an enlarged manner at the bottom in FIG. 26;

FIG. 27 shows the curve profile 20 of the symbol positions for the first search band Poo;

FIG. 28 shows the profile fᵢ(y) of the symbol positions along the next block column Bᵢ being determined by displacing the search band 19 toward the left;

FIG. 29 shows the curve profile 20 of the symbol positions of the second search band P₃₉;

FIG. 30 shows the further decrementing of the running variable i in step 430 causing a further displacement of the search band 19 toward the left, the limits of the new search band P₃₉ again resulting from the parallel displacement of the profile f₃₉(y) of the symbol positions in the previous search band P₃₉ or along the previous block column B₃₉;

FIG. 31 shows an enlarged excerpt from the complete image 12 where consideration is given to a block column 4 or respectively a search band P₄ which results from the previous symbol profile f₅(y) by way of parallel displacement;

FIG. 32 shows the curve profile 20 of the symbol positions for the 37th search band P₄ (block column B₄);

FIG. 33 shows where all symbol profiles fᵢ(y) of the block columns Bᵢ to the left of the complete image center, i.e., for i≤└Nₓ/2┘ are determined;

FIG. 34 shows the fitted column profiles 20 of all Nₓ block columns Bᵢ;

FIG. 35 shows the global correction for all second-order coefficients;

FIG. 36 shows the fitted row profiles 23 of all N_{y} block rows Bᵢ;

FIG. 37 shows a complete image 12; and

FIG. 38 shows the result of an inverse projection (inverse homographic projection or inverse transformation).

### DETAILED DESCRIPTION

The present invention proposes a method for evaluating a two-dimensional matrix code composed of symbol series arranged in rows and columns, wherein the matrix code is contained in a complete image composed of pixel series arranged in rows and columns and the profiles of the individual symbol series are reconstructed on the basis of the complete image and samples are ascertained at the intersection points of the symbol series profiles, comprising the following steps:
a ascertaining the approximate position of the symbols along the symbol series in the direction of a first dimension of the complete image successively,
   i. for a number q of groups of k_{P} mutually adjacent pixel series in the direction of the first dimension by a procedure in which, for each of the q groups, an even function, in particular a squaring or absolute value formation, is applied to the DC component-free signal profiles along the individual pixel series in the direction of the first dimension, and the signal profiles thus processed are subsequently summed to form a summation signal, wherein the summation signal is subjected to bandpass filtering and those pixel positions are ascertained at which the bandpass-filtered summation signal has in each case a local maximum, or
   ii. for a number q of pixel series distributed over the complete image in the direction of the first dimension by a procedure in which an even function, in particular a squaring or absolute value formation, is applied to the DC component-free complete image, the complete image thus processed is filtered in the direction of the second dimension with a transposed vector of ones having k_{P} elements and is subsequently subjected to bandpass filtering in the direction of the first dimension and in the q pixel series those pixel positions are ascertained at which the bandpass-filtered signal along the respective pixel series has in each case a local maximum,
   and wherein the ascertained pixel positions are used as position of the symbols in the direction of the first dimension;
b ascertaining the profiles of the individual symbol series along the other dimension of the complete image successively by a procedure in which a search band is defined for each symbol series along the other dimension and those ascertained symbol positions which lie within the corresponding search band are firstly ascertained, wherein for each of the profiles of the individual symbol series along the other dimension, a mathematical model of a curve describing the corresponding profile is fitted so that the curve interpolates and smooths the symbol positions within the respective search band;
c repeating step a for the other dimension in order to ascertain the approximate position of the symbols along the symbol series in the direction of said other dimension; and
d repeating step b for the first dimension in order to ascertain the profiles of the individual symbol series along the first dimension of the complete image.

The core of the present invention consists in reconstructing the sampling points with the aid of the properties of the data modulation taking account of the channel distortions and reducing the spatial intersymbol interference by decorrelation of the sampled symbols. The method determines optimum positions for the sampling of the symbols of the matrix code since the sampling points form the respective center points of the data blocks or symbols where the spatial intersymbol interference is the least and the constructive superpositions are the greatest. The method thus enables matrix codes to be sampled robustly with minimal errors, even matrix codes having high information density.

In accordance with one embodiment variant, before ascertaining the symbol positions, an image area (code area) occupied by the matrix code can be ascertained in a starting image which is formed by a camera recording or was obtained from camera recordings, wherein the image area is mapped onto the complete image by a homographic projection.

In accordance with one embodiment variant, before ascertaining the symbol positions, the complete image can be subjected to low-pass filtering.

In accordance with one embodiment variant, the q groups of k_{P} mutually adjacent pixel series can be formed so that they do not have any pixel series in common. That means that the groups do not overlap.

In accordance with one embodiment variant, by ascertaining the intersection points of the symbol series profiles, a grid of sampling points can be determined and the matrix code can be subsequently sampled at these sampling points in order to ascertain the samples. The matrix code can alternatively be sampled by a process in which the matrix code is firstly sampled along entire symbol series profiles in the direction of a first dimension, and from these sampling series thus formed only those values which lie at an intersection point with one of the symbol series profiles in the direction of the other dimension are subsequently used as samples. Consequently, the previously ascertained samples between two intersection points are discarded again.

In accordance with one embodiment variant, before the squaring, a DC component can be removed from the signal profiles along the individual pixel series or from the complete image, wherein the term DC component denotes the DC component of the respective signal profile or that of the entire complete image. The DC component can, for example, be the sum of all values divided by the number of values.

In accordance with one embodiment variant, by means of an inverse homographic projection, the sampling grid can be mapped back onto the starting image and the matrix code can there be sampled.

In accordance with one embodiment variant, the center of the complete image can be used as the start for the first search band.

In accordance with one embodiment variant, the limits of the second and each further search band can be defined by parallel displacement of the profile of the symbol series which was ascertained for the previous search band.

In accordance with one embodiment variant, the bandpass filtering can be effected by a digital filter, in particular an FIR (Finite Impulse Response) filter, with an average frequency which substantially corresponds to the quotient of the number of symbols and the number of pixels in the direction of the dimension considered. In other words, the average frequency corresponds to the inverse of the block size in the direction of the signal profiles considered, expressed in the number of pixels onto which a block in the complete image was ideally projected.

In accordance with one embodiment variant, the model can be a 2^{nd} or 3^{rd} order polynomial. A higher order is not advisable since overfitting occurs in this case.

In accordance with one embodiment variant, after step b. a global correction of the profiles of the individual symbol series along the first dimension of the complete image and/or after step d. a global correction of the profiles of the individual symbol series along the second dimension of the complete image can be carried out by a procedure in which the coefficients of the respective mathematical model describing the individual profiles along the respective dimension are fitted so that the coefficients of the same order lie on a continuous curve. This corrects errors in the symbol series profiles at the edges of the complete image.

In accordance with one embodiment variant, the starting image can be filtered before sampling using a modified matched filter. This has the advantage that the loss of signal quality owing to the correlations of neighboring pixels (crosstalk) that are artificially produced by the image sensors of the camera is already minimized before sampling. The modified matched filter can be a matched filter having a spatial extent that is approximately 20% smaller than an unmodified matched filter.

In accordance with one embodiment variant, after the sampling for compensation of spatial intersymbol interference, the samples can be subjected to equalization filtering by means of a two-dimensional digital filter FIR, the coefficients of which are ascertained from the correlation of the samples. The equalization filtering can, for example, be effected via a filter of the form:

$${F}_{ISI} = [ \begin{matrix}0 & - {r}_{3} & 0 \\ - {r}_{1} & 1 + {r}_{1} + {r}_{2} + {r}_{3} + {r}_{4} & - {r}_{2} \\ 0 & - {r}_{4} & 0\end{matrix} ]$$

in which r₁, r₂, r₃, r₄ are correlation coefficients which are calculated according to the formula:

$$corr ( {M}_{a} , {M}_{b} ) = \frac{{\sum }_{i} {\sum }_{j} ( {M}_{a , ij} - \overline{{M}_{a}} ) ( {M}_{b , ij} - \overline{{M}_{b}} )}{\sqrt{( {\sum }_{i} {\sum }_{j} {( {M}_{a , ij} - \overline{{M}_{a}} )}^{2} ) ( {\sum }_{i} {\sum }_{j} {( {M}_{b , ij} - \overline{{M}_{b}} )}^{2} )}}$$

r₁=corr(M₀,M₁)

r₂=corr(M₀,M₂)

r₃=corr(M₀,M₃)

r₄=corr(M₀,M₄),

wherein M₀, M₁, M₂, M₃, M₄ is in each case a matrix within which the samples are defined as follows:
M₀ includes the samples of row 2 to row N_{y}−1 and column 2 to column Nₓ−1 of the matrix code,
M₁ includes the samples of row 2 to row N_{y}−1 and column 1 to column Nₓ−2 of the matrix code,
M₂ includes the samples of row 2 to row N_{y}−1 and column 3 to column Nₓ of the matrix code,
M₃ includes the samples of row 1 to row N_{y}−2 and column 2 to column Nₓ−1 of the matrix code, and
M₄ includes the samples of row 3 to row N_{y} and column 2 to column Nₓ−1 of the matrix code;

wherein Nₓ is the number of columns of the matrix code and N_{y} is the number of rows of the matrix code. This equalization filtering brings about a reduction of the spatial intersymbol interference after sampling by removal of the correlation between neighboring data blocks (neighboring symbols).

The present invention furthermore proposes a reader and a software application for evaluating a two-dimensional matrix code composed of symbol series arranged in rows and columns, wherein the reader and the software application are each configured to carry out the method according to the present invention. The software application is provided for a reader and comprises instructions for carrying out the method when they are executed on the reader.

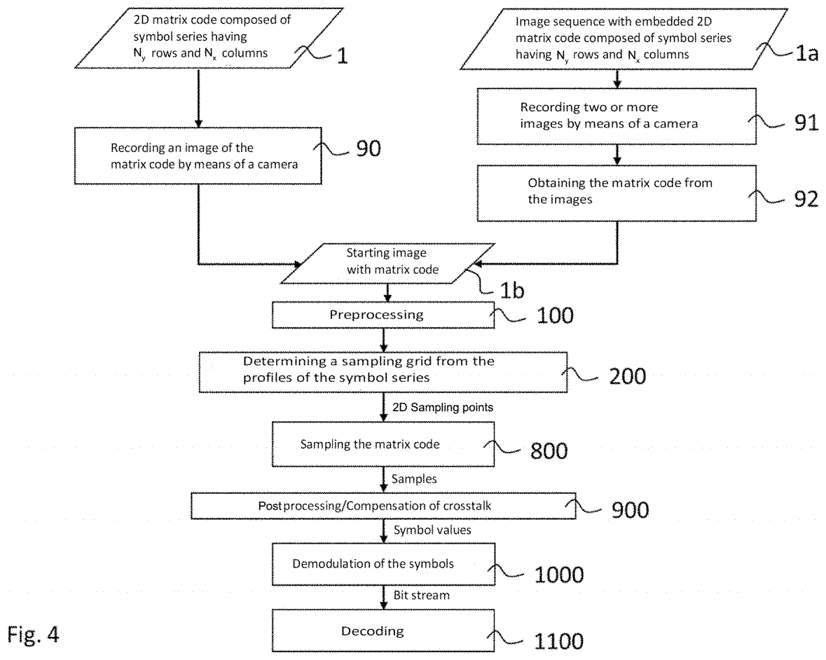

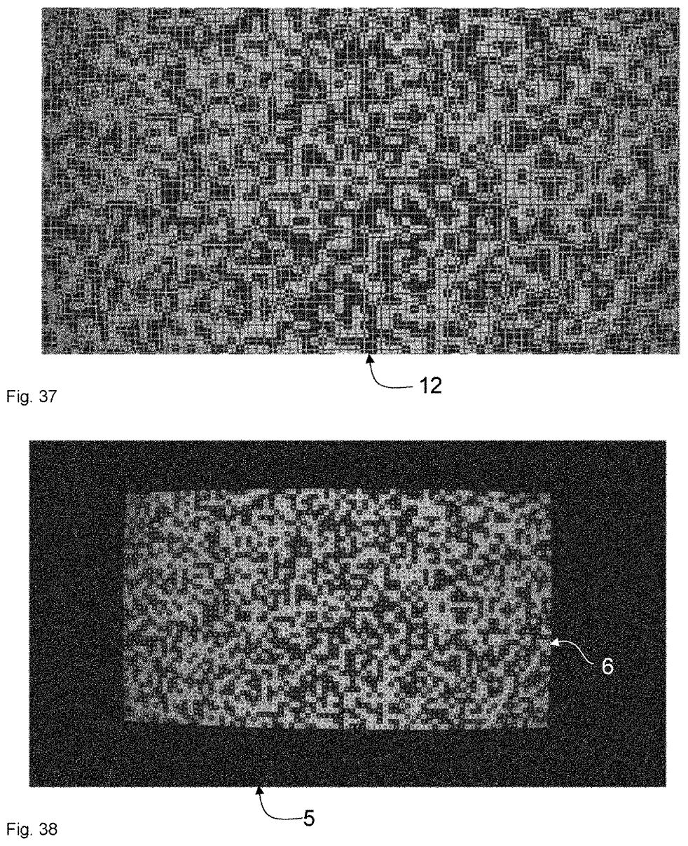

The method of the present invention is explained in greater detail below under reference to the accompanying FIGS. 4 to 38.

FIG. 4 shows the general sequence of the method, wherein the heart of the present invention resides in method steps 100 to 900 and the starting point of the method is a starting image 1b containing a two-dimensional matrix code 1 to be sampled. The starting image 1b can be a camera recording, for example, which was created from the matrix code 1 with of a digital camera in step 90. In this case, the matrix code can be present visibly e.g., on a printing medium (e.g., paper) or on a digital display (screen). Alternatively, the starting image 1b can be the result of digital image processing, step 92, in which the matrix code 1 was obtained from two or more individual images previously recorded with a digital camera, see step 91. Such digital image processing or matrix code obtaining is described, for example, in the German patent applications DE 102014008405 A1 and DE 102018124339 A1 cited above. In this case, a matrix code 1 is embedded into an image sequence 1a (video) to be rendered on a digital display so that the difference between two successive images of the image sequence forms the matrix code. In this way, matrix codes can be embedded in a hidden manner in videos invisibly to the eye and can be made visible by corresponding processing in a reader which has previously recorded the images or filmed the screen. Among experts, this type of transfer is referred to as optical free-space transfer.

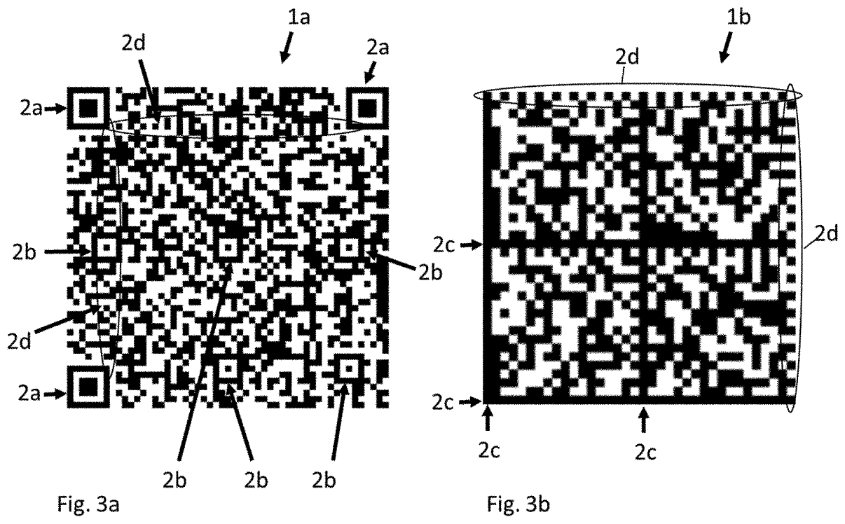

The method presupposes that the number of symbol series of the matrix code 1 that are arranged in rows and columns is known. The term series forms the generic term for the terms row and column, and so a symbol series, block series or pixel series hereinafter can mean both a row and a column of symbols, blocks or pixels, unless indicated otherwise. Without restricting the generality of the method, the two dimensions of the matrix code and of the images respectively considered (starting image, complete image) are referred to below as dimension x and dimension y. The method presented here is functional irrespective of the assignment of the two dimensions to the rows or columns; i.e., the optimum sampling points can be detected firstly for the rows and then for the columns, or vice versa. It is assumed that the matrix code has N_{y} rows and Nₓ columns. In other words, the matrix code has Nₓ data blocks or symbols in the direction of the rows and N_{y} data blocks or symbols in the direction of the columns. This code size can optionally be defined beforehand in the software application that carries out the method, e.g., by numerical predefinition or by selection of a specific code variant to which a defined code size is assigned. However, it is also possible to recognize the number of data blocks automatically on the basis of suitable patterns in the matrix code, e.g., so-called timing patterns 2d, see FIGS. 3a and 3b.

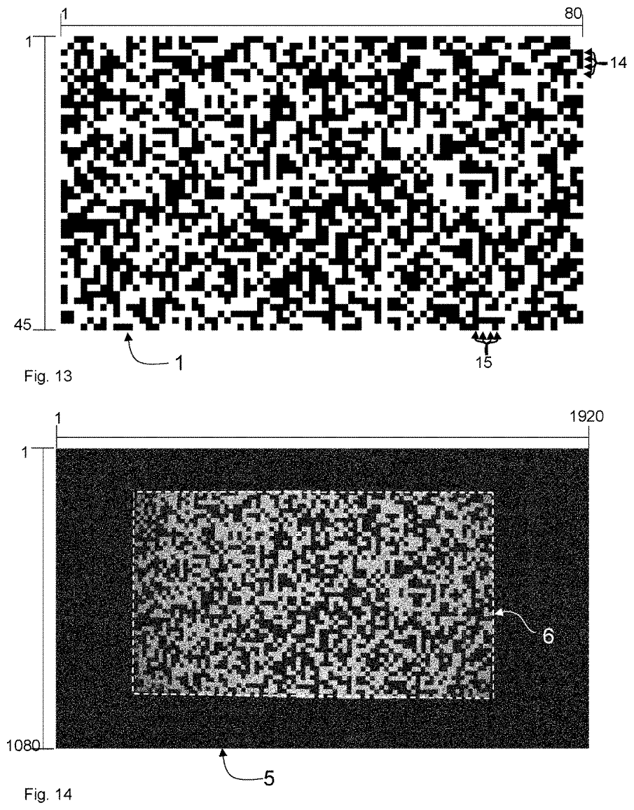

Hereinafter, purely by way of example, the matrix code 1 composed of Nₓ=80 columns 15 and N_{y}=45 rows 14 as illustrated in FIG. 13 is assumed and the method is elucidated on the basis of this exemplary code. The symbols of this code are blocks or data blocks, and so reference is also made to block series or block rows and block columns. The values of the symbols are binary here in a traditional way, a symbol being formed by a dark or black or bright or white block. In order to simplify the description, it is assumed hereinafter that the block size of the data blocks is identical in both dimensions. The method can be adapted straightforwardly for non-square data blocks. Furthermore, it is assumed that the symbols in the matrix code 1 do not have a systematic structure, i.e., the number of bright symbols and the numbers of dark symbols are almost equal, and that these symbols are distributed randomly in the entire code region. This is automatically provided in many systems with a high information density by way of preprocessing of the data at the transmitter end. It should be noted that the method according to the present invention is provided as intended for high-density matrix codes. The fact that the dimension Nₓ×N_{y} is here is significantly smaller, or the block size B is significantly larger, than in high-density matrix codes, serves merely for elucidation.

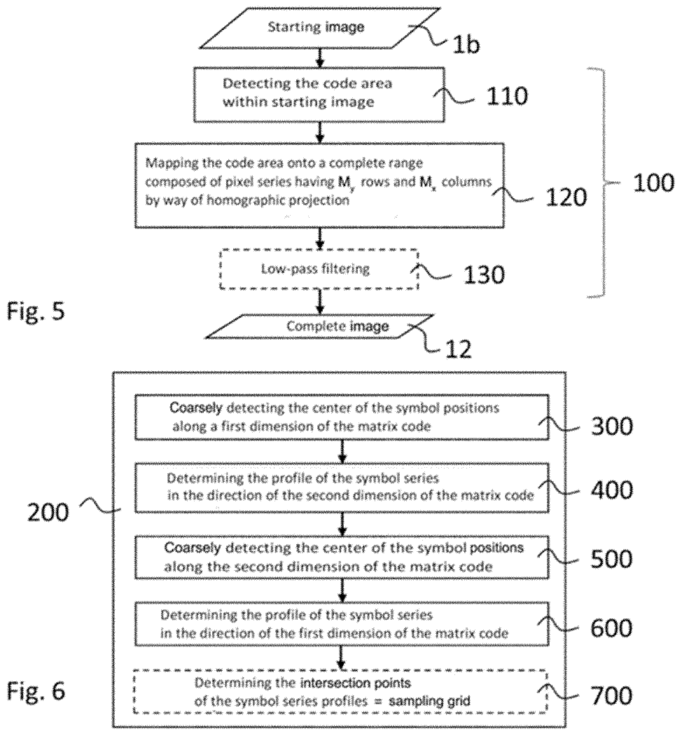

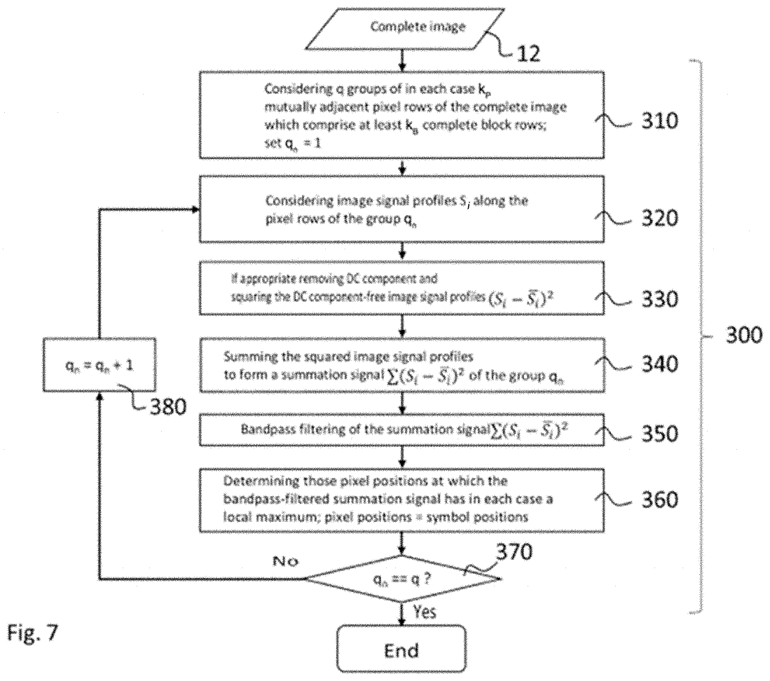

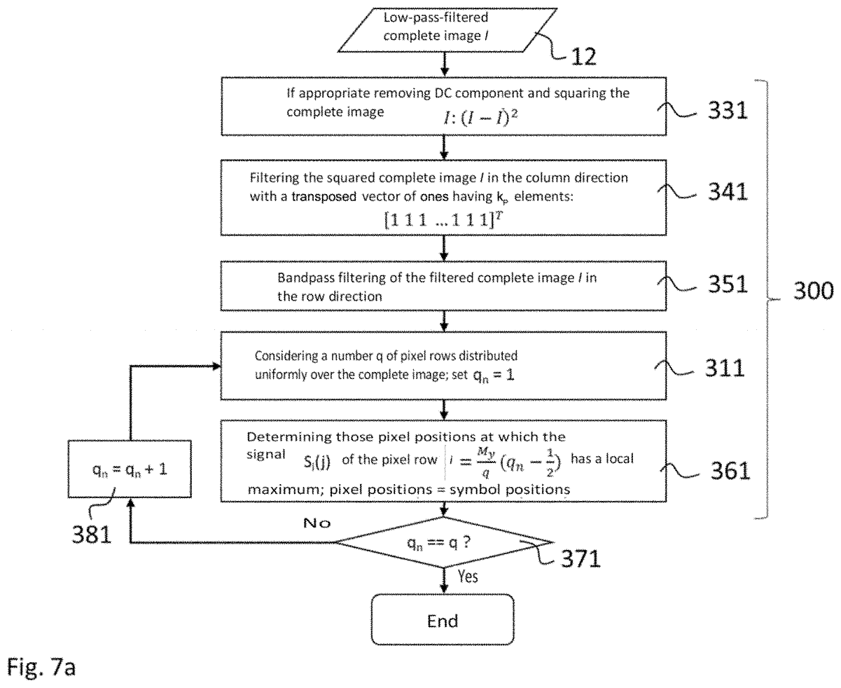

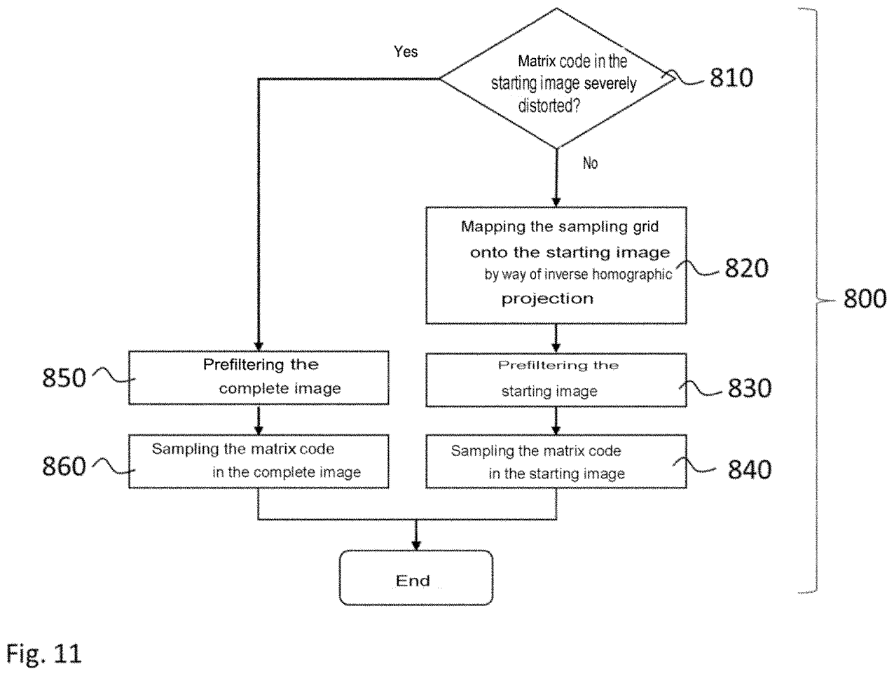

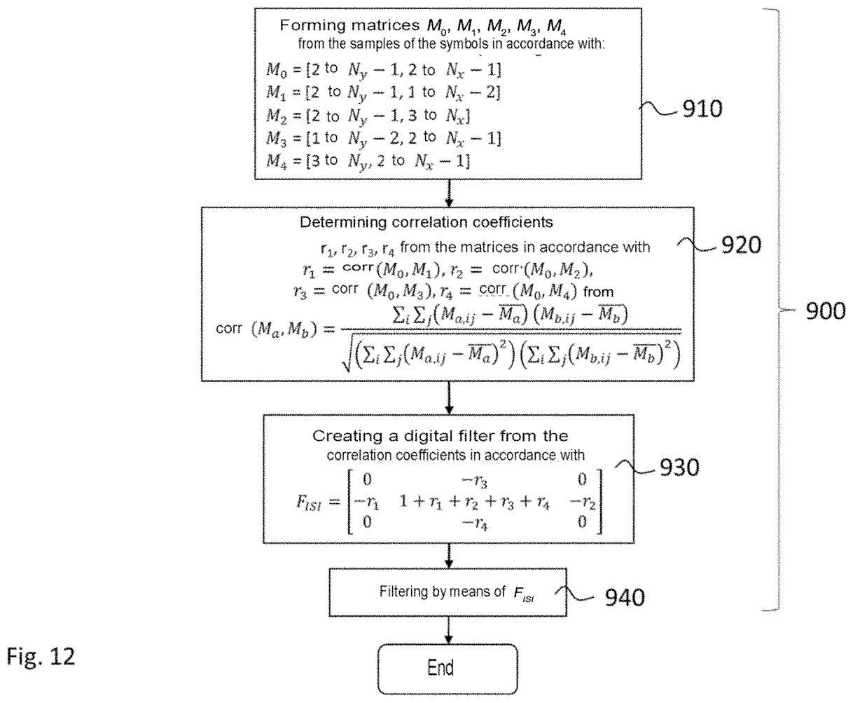

The starting image 1b is firstly subjected to preprocessing, which is illustrated in more specific detail in FIG. 5, in step 100. This is followed by determining the profiles of the symbol series and also a sampling grid for sampling the matrix code from the symbol series profiles, step 200. This is illustrated in more specific detail in FIG. 6 and is elaborated in FIGS. 7 to 10. The sampling grid is formed by a two-dimensional grid of sampling points. This is followed by sampling the matrix code 1 in accordance with the sampling grid, step 800, which is concretized with reference to FIG. 11. Postproces sing then follows, in which the effect of crosstalk is compensated for and which yields the symbol values, step 900. This is elaborated in FIG. 12. Finally, in a manner known per se, the symbol values are converted to a bitstream by demodulation of the symbols, step 1000, and the bitstream is decoded, step 1100.

FIG. 5 illustrates the method steps which are or can be part of the preprocessing applied to the starting image 1b. One exemplary starting image 1b is illustrated in FIG. 14. It is a camera recording 5 containing the matrix code 1 distorted firstly in perspective and secondly owing to lens distortion. Perspective distortion is recognizable from the trapezoidal shape of the code area, and the lens distortion is recognizable from the bulbous contour of the code edges. The camera recording 5 has a full HD resolution of 1920×1080 pixels.

Firstly, in the starting image 1b or the camera recording 5, the code area 6 occupied by the matrix code 1 is detected, step 110. This can be done in various ways, depending on the matrix code and the transfer thereof, the methods for code area detection being known per se. The code area 6 can be ascertained on the basis of the corners or the edges of the matrix code 1. This can be effected e.g., on the basis of localization patterns 2a (FIG. 3a) which are embedded in the matrix code 1. The localization of the code area via patterns is described, for example, in the relevant standards: ISO/IEC 18004 (2015) Information technology—Automatic identification and data capture techniques—QR Code bar code symbology specification, International Organization for Standardization, or ISO/IEC 16022 (2006) Information technology—Automatic identification and data capture techniques—Data Matrix bar code symbology specification, International Organization for Standardization. Localization patterns reduce the number of data blocks that can be used for payload data since they themselves take up space in the matrix code 1.

If there is a clear difference in contrast between the code area 6 and the frame surrounding the matrix code 1, this difference in contrast can also be used to determine the position of the code within the starting image 1b. Furthermore, localization of the code area without patterns is described in: Katona, M., Nyúl, L. G, A novel method for accurate and efficient barcode detection with morphological operations, 8th International Conference on Signal Image Technology and Internet Based Systems, SITIS 2012r, 307-314. Li, H., Li, J., Hwang H., Jiang, X., Cheung, J., and also in the US patent application US 2009/0212112 A1.

Another variant which can be employed when generating the matrix code from the difference between two images of an image sequence is the use of localization patterns in the superposed image, i.e., that image in which the matrix code is embedded (subordinate): this is described, for example, in the technical publication: Xu, J., Klein, J., Brauers, C., Kays, R., Transmitter design and synchronization concepts for DaViD display camera communication, 2019 28th Wireless and Optical Communications Conference, WOCC 2019—Proceedings.

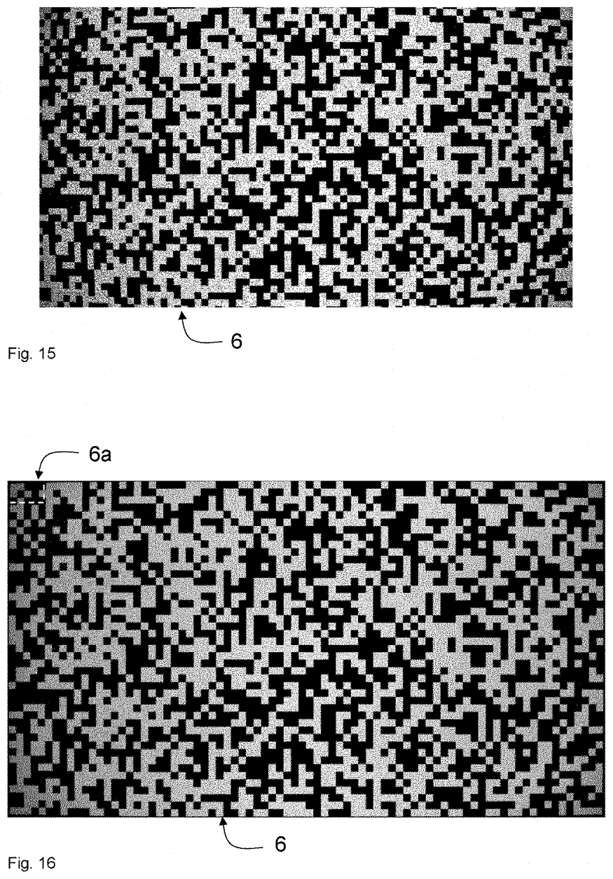

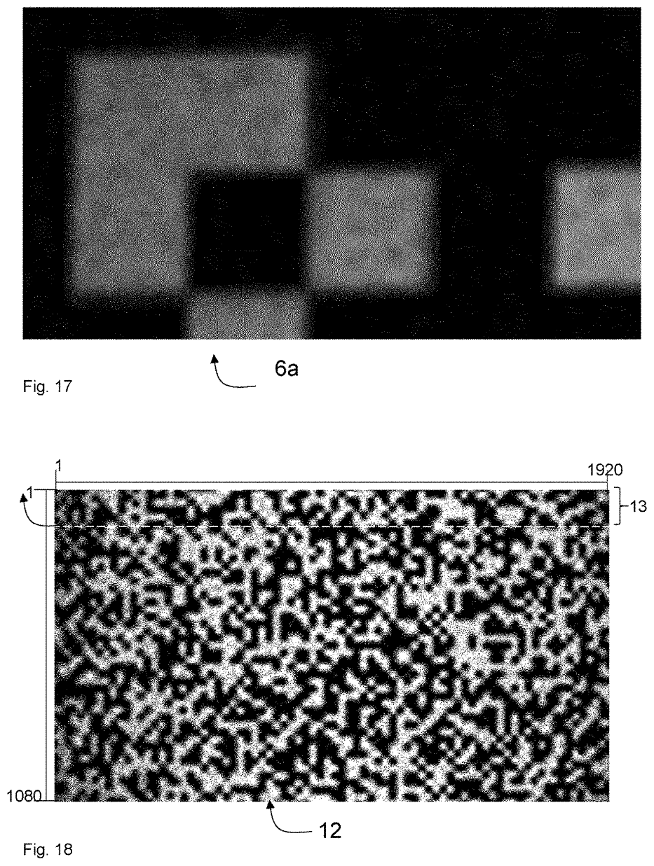

If the positions of the four corners of the matrix code 1, e.g., expressed in pixel positions, are ascertained, in the simplest case the code area 6 can be defined by straight connections between the corners, so that it forms a quadrilateral. FIG. 15 shows the matrix code if it were cut out according to the ascertained code area 6, i.e., along the quadrilateral from the camera recording 5. In order to take account of the lens distortion and to prevent data blocks from being excluded from the quadrilateral on account of the bulbous code edges, which is recognizably the case in FIG. 15, an offset of a few pixels, e.g., 3 to 15 pixels, can be added to each of the four corner positions in one or both dimensions. FIG. 16 shows the matrix code 1 if it is cut out from the camera recording 5 according to the ascertained code area 6 together with an offset of the corners. This becomes clear from the black frame in the corners, which becomes smaller toward the respective edge center. An enlargement of the top left corner 6a of the code area 6 is shown in FIG. 17.

In step 120, the ascertained code area 6 is mapped onto a complete image 12 consisting of pixel series having M_{y} rows and Mₓ columns. This is done mathematically by means of a homographic projection, also called projective transformation. By way of example, the complete image can have a resolution of M_{y}=1080 rows and Mₓ=1920 columns. It is appropriate if the resolution of the complete image is chosen to be identical to the resolution of the camera which captured the camera recording 5. Homography is the projection of points of one planar surface onto another planar surface. It is described, for example, in Hartley, Richard, and Andrew Zisserman, Multiple view geometry in computer vision, Cambridge University Press, 2003, pp. 87-127. In this case, on the basis of the four defined corner points of the code area 6, a homography matrix H is calculated, for example, so that:
the top left corner point of the code area 6 is mapped onto the corner point (1, 1) of the complete image, i.e., onto the first pixel of the first row of the complete image,
the top right corner point of the code area 6 is mapped onto the corner point (1920, 1) of the complete image, i.e., onto the last pixel of the first row of the complete image,
the bottom left corner point of the code area 6 is mapped onto the corner point (1, 1080) of the complete image, i.e., onto the first pixel of the last row of the complete image, and
the bottom right corner point of the code area 6 is mapped onto the corner point (1920, 1080) of the complete image, i.e., onto the last pixel of the last row of the complete image.

Via the homography matrix H, each point of the code area 6 or each pixel of the starting image 1b within the code area can then be assigned a point or pixel of the complete image. Since the code area 6 is smaller in terms of pixels than the complete image, the homographic projection in step 120 results in an interpolation of the code area 6 or of the matrix code 1 and hence an equalization. With regard to a matrix code having 45 rows and 80 columns, the projection means that each symbol or each data block of the matrix code 1 in the chosen complete image subsequently has a width Bₓ of Mₓ/Nₓ=24 pixels in the row direction and a width B_{y} of M_{y}/N_{y}=24 pixels in the column direction. In principle, however, the width in the row and column directions need not be identical.

Illustratively, the homographic projection or projective transformation is effected by firstly generating a trivial sampling grid, projecting it via the homography matrix H perspectively onto the matrix code 1 or the matrix code area 6, sampling the code or the area with the transformed grid, and then assigning the samples (interpolated values) once again on the complete image from (x, y)=(1, 1) to (1920, 1080). The code is equalized as a result. A trivial sampling grid is understood to mean a uniform grid of points which are equidistant to one another in each case in both dimensions. It should here be noted that the sampling grid has at least twice as many points in the direction of both dimensions compared with a number of symbols/data blocks in the matrix code, in order to avoid aliasing effects. This is satisfied with the choice of a sampling grid of 1920×1080 points for the matrix code 1 having 80×45 data blocks. If the condition is not satisfied, a finer sampling grid can be generated by oversampling of the complete image.

It should be noted that the image data representing the starting image 1b and the complete image can, for example, be present in the form of a data matrix since this simplifies the data processing. Each entry of this data matrix then includes the value of a corresponding pixel i, j of the image.

FIGS. 15 and 16 show the matrix code 1 or the code area 6 after the homographic projection thereof onto the complete image, in which case the above-described offset of the corners was taken into account in FIG. 16 and is absent in FIG. 15.

In step 130, the complete image is subsequently subjected to low-pass filtering, the result of which, the low-pass-filtered complete image 12, is illustrated in FIG. 18. The low-pass filtering is optional. It has the advantage that the hard transitions from a positive sample to a negative sample that are possibly present are converted into continuous transitions, which are recognizable more reliably for further signal processing steps, see step 330. The cut-off frequency of the low-pass filter should be chosen so that the data pattern is not suppressed, e.g., at 1/Bₓ and 1/B_{y} for the respective dimension x and y. The preprocessing 100 is thus ended and is followed by the determination of the sampling grid, step 200. The optimum positions for the sampling of the symbols of a matrix code are typically the respective center points of the data blocks, since there the spatial intersymbol interference is the least and the constructive superpositions are the greatest. The search for the two-dimensional sampling points is non-trivial, particularly if a non-negligible lens distortion of the camera is present or/and the matrix code 1 in the starting image 1b has a low contrast. A simplification of this two-dimensional problem can be achieved by determining the symbol positions separately for the rows and columns of the matrix code 1 and constructing the final sampling points on the basis thereof.

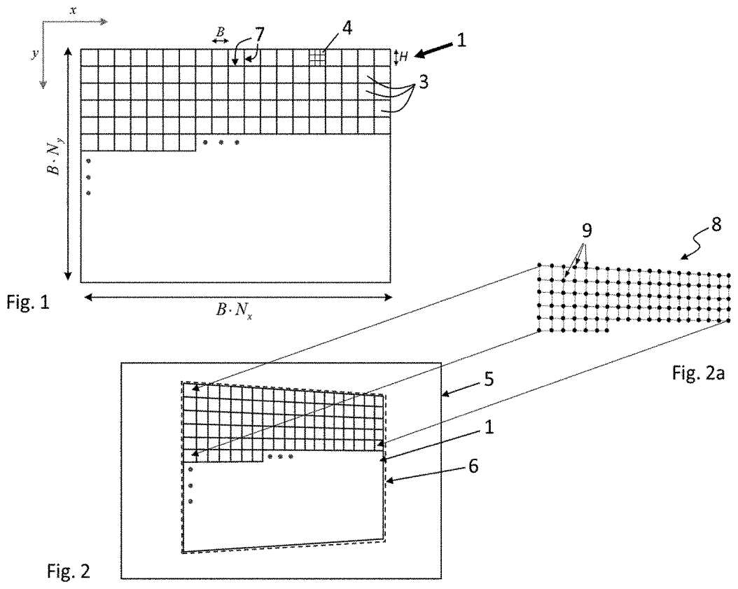

As shown in FIG. 6, the determination of the sampling grid 200 firstly comprises a coarse detection of the center of the symbol positions along a first dimension of the matrix code 1, step 300, and the subsequent determination of the profile of the symbol series in the direction of the second dimension of the matrix code 1 from the previously ascertained symbol positions, step 400. These two successive steps are then repeated for the respective other dimension. This involves firstly a coarse detection of the center of the symbol positions along the second dimension of the matrix code 1, step 500, and the subsequent determination of the profile of the symbol series in the direction of the first dimension of the matrix code 1 from the ascertained symbol positions along the second dimension, step 600. In the following example, the first dimension is the row direction, i.e., the x-direction in FIG. 1 and the second dimension is the column direction, i.e., the y-direction in FIG. 1. This can of course also be reversed. Once all horizontal and vertical profiles of the symbol series are known, the intersection points thereof are ascertained, step 700. The intersection points form the points of the sampling grid sought.

FIG. 7 illustrates the individual steps when determining the center of the symbol positions along the rows of the matrix code 1 in accordance with step 300, the matrix code 1 in FIG. 13 and the complete image 12 in FIG. 18 serving for elucidation below. The central concept of the first method section 300 consists in carrying out, for the purpose of detecting the symbol positions on the rows, spatial processing of the complete image 12 in order to generate a peak value in the respective block center.

The following embodiment variant involves carrying out the center determination for a number q of rows distributed uniformly over the matrix code 1 and the complete image 12. For this purpose, q groups of in each case k_{P} mutually adjacent pixel rows of the complete image 12 are considered, step 310, the number of mutually adjacent pixel rows of the complete image 12 which are combined to form the group being of a sufficient magnitude that they comprise at least kB complete block rows of the matrix code. The central concept in this procedure consists in recognizing symbol transitions 7 between the individual symbols, which is scarcely possible, however, in the case of identical neighboring symbols. In order to increase the probability of occurrence of symbol transitions, therefore, the spatial correlation within a data block and also the correlation of the symbol positions in neighboring block rows and the statistical independence between data blocks in different block rows are utilized by carrying out an accumulation over neighboring rows. This is explained below.

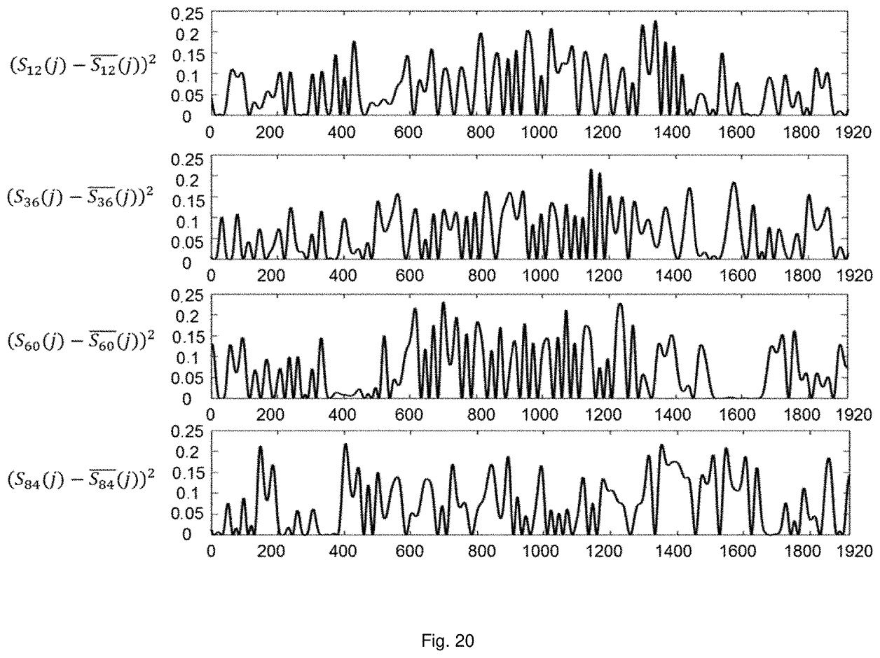

In the following example, the center of the symbol positions is ascertained for q=9 rows, cf. FIG. 20. However, there may also be more or fewer. The q groups are chosen here so that they do not overlap, i.e., no pixel row is in two groups at the same time. Ideally, all groups are of the same size. In this case, each group has k_{P}=M_{y}/q or 1080/9=120 rows, which, given a block size B_{y}=M_{y}/Mₓ in the column direction of B_{y}=1080/45=24 pixel rows, means that each group comprises k_{B}=k_{P}/B_{y}=5 block rows. The determination of the center of the symbol positions along the rows of the matrix code 1 is carried out in a representative manner for the respective center of each group, i.e., in the exemplary case considered, for the block rows 3, 8, 13, 18 etc. or generally for the block rows q·k_{B}−└k_{B}/2┘ (the symbols └x┘ represent the so-called floor function) or for the pixel rows 60, 180, 300 etc. or generally for the pixel rows q·k_{P}−└k_{P}/2┘. A group may also be regarded as a window 13 of the complete image 12 and the division and evaluation of the individual pixel rows of the complete image 12 in groups may be referred to as windowed processing.

Beginning with the first group qₙ=1 steps 320, 330, 340, 350 and 360 are carried out successively for each group qₙ, wherein after the consideration of a group qₙ, the running variable qₙ is increased by one, step 380, unless the last group qₙ=q was finally considered, i.e., the number q of groups present has been reached. This is checked in step 370.

For each group qₙ, only the image signal profiles Sᵢ(j) along the individual pixel rows i are considered, step 320. An image signal profile is the sequence S of the pixel values over the pixel index j in the row direction (column index j). In practice, the pixel values are brightness values, and so the image signal profile corresponds to a brightness profile along the corresponding pixel row. A high pixel value then represents a bright symbol, and a low pixel value a dark symbol. However, this assignment can also be inverted.

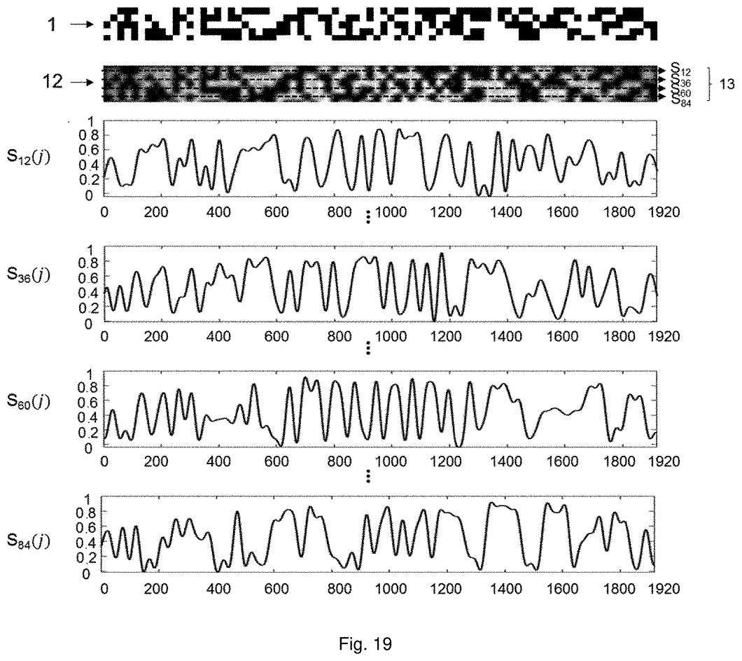

B_{y} way of example, FIG. 19 illustrates four image signal profiles Sᵢ(j) of the first group qₙ=1 where j=1 . . . 1920, specifically for the pixel rows i=12, 36, 60 and 84. These pixel rows correspond to the respective row center of the first four symbol rows of this group qₙ. For comparison, the k_{B} symbol rows of the original matrix code 1 and also the k_{P} pixel rows of the complete image 12 for the window 13 relevant here are illustrated once again at the top in FIG. 19, and the image signal profiles S₁₂, S₃₆, S₆₀, S₈₄ are marked in said window. The pixel values lie between 0 and 1, wherein 0 represents a black symbol and 1 represents a white symbol. However, these ideal values are rarely attained, or are not attained at all in the case of logic 1. The image signal profiles Sᵢ(j) thus represent brightness profiles.

It should be noted that steps 310 and 320 are not strictly speaking independent method steps. They rather serve for the logical structuring and algorithmic representation of the method sequence.

Depending on the origin of the starting image 1b, the image data thereof may be free of a DC component or may contain a DC component. While the image data in the case of a camera recording contain a DC component, the latter is absent if the starting image or the matrix code 1 was generated from the difference between two images of the image sequence in step 91 in accordance with the methods in DE 102014008405 A1 or DE 102018124339 A1. However, the evaluation of the pixel rows of the group qₙ requires that no DC component S̅ₗ be present, and so, in the case of image signal profiles beset by a DC component, the DC component S̅ₗ must firstly be removed. This is taken into account as part of step 330. As a result of the removal of the DC component the signal profiles are shifted downward, i.e., become partly negative. Zero crossings between data blocks at symbol transitions are generated as a result.

The DC component can be removed e.g., by subtraction of the mean value. As mean value (DC component), it is possible to use the sum of all the pixel values divided by the number of pixels, i.e. the arithmetic mean. This can be effected in a series-related, group-related or complete image-related manner. In the case of a series relation, therefore, all pixel values of a series, e.g., of the i-th row Sᵢ(j) where j=1 . . . Mₓ, are summed and subsequently divided by the number of pixels of the series, e.g., M. In the case of a group relation, all pixel values of a group qₙ are summed and subsequently divided by the number of pixels of the group (k_{P}·Mₓ). And in the case of a complete image relation, all pixel values of the complete image 12 are summed and subsequently divided by the number of pixels of the complete image 12 (Mₓ·M_{y}).

The DC component-free image signal profile Sᵢ−S̅ₗ of each row i of the group qₙ is subsequently squared in step 330. In other words, the individual pixel values of each pixel row i are squared, if appropriate after removal of the DC component. The squared DC component-free image signal profiles (Sᵢ−S̅ₗ)² are depicted in FIG. 20 for the four pixel rows 12, 36, 60 and 84 considered. Squaring is just one example of the application of an even function to the signal profiles, here in the form of a nonlinear distortion of the signal with an even exponent (here two). In principle, any arbitrary even nonlinear distortion, e.g., higher even exponents, or some other even function such as e.g., absolute value formation is here possible.

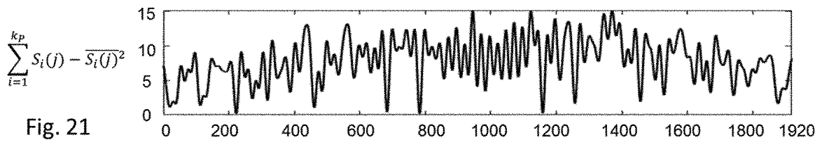

Squaring has the effect that the sign information is removed and the zero crossings are converted into amplitude dips of the signal. Ideally, Nₓ peak values arise in the corresponding block centers along the block rows. If only a single block row is considered, the peak values will never be complete, however, since a change between symbol values (bright-dark) is not present at each block limit. Moreover, precisely at low contrast the influence of other disturbances, e.g., image noise, may still be high. An accumulation over neighboring rows is carried out for this reason. This increases the probability of occurrence of symbol transitions by utilizing the spatial correlation within a data block and also the correlation of the symbol positions in neighboring block rows and the statistical independence between data blocks in different block rows. In this regard, step 340 then involves summing the k_{P} squared image signal profiles (Sᵢ−S̅ₗ)² to form a summation signal Σ(Sᵢ−S̅ₗ)² of the group qₙ, which is shown in FIG. 21. In this case, the pixel values are added column by column, i.e., all squared pixel values of the k_{P} rows of the group qₙ are added for each column j. Illustratively, that means that all 120 pixel values of the first column are added, of the second column are added, and of the third column and each further column j are in each case added.

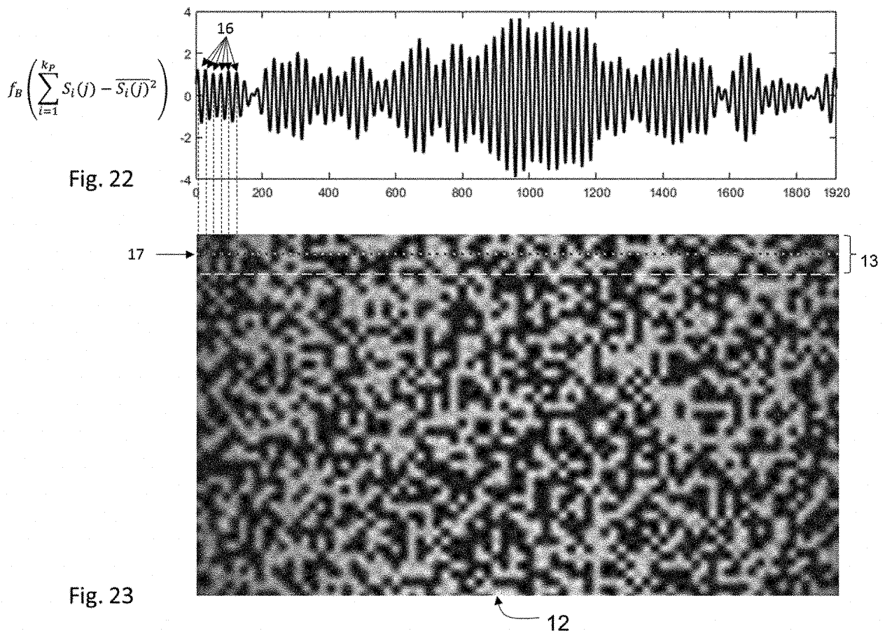

The summation signal Σ(Sᵢ−S̅ₗ)² thus formed is subsequently filtered via a bandpass filter, step 350. The bandpass-filtered summation signal f_{B} is depicted in FIG. 22. In this case, a digital finite impulse response filter (FIR filter) can, for example, be used, having an average frequency of Nₓ/Mₓ=1/Bₓ (block number/image width=1/block size in dimension x). With Bₓ=24 pixels, the average frequency (symbol frequency) is 0.042 line pairs per pixel (alternative dimension in the image field for hertz). This firstly provides a continuous signal profile in the region of the zero crossings and secondly reduces the influence of noise.

This is followed by determining those pixel positions at which the bandpass-filtered summation signal has in each case a local maximum 16 or a peak value, step 360. The individual pixel positions roughly correspond to the center of the individual symbol positions, i.e., each block column center. This then results in a point profile 17 in the row direction, which is illustrated in the complete image 12 in FIG. 23. The ascertained pixel positions are stored in the form of the index j of the respective pixel at which the maximum 16 is present, in a vector. The associated symbol indices of the detected peak values are not known initially, however, owing possibly to an incomplete number of potential symbol positions in a group being detected.

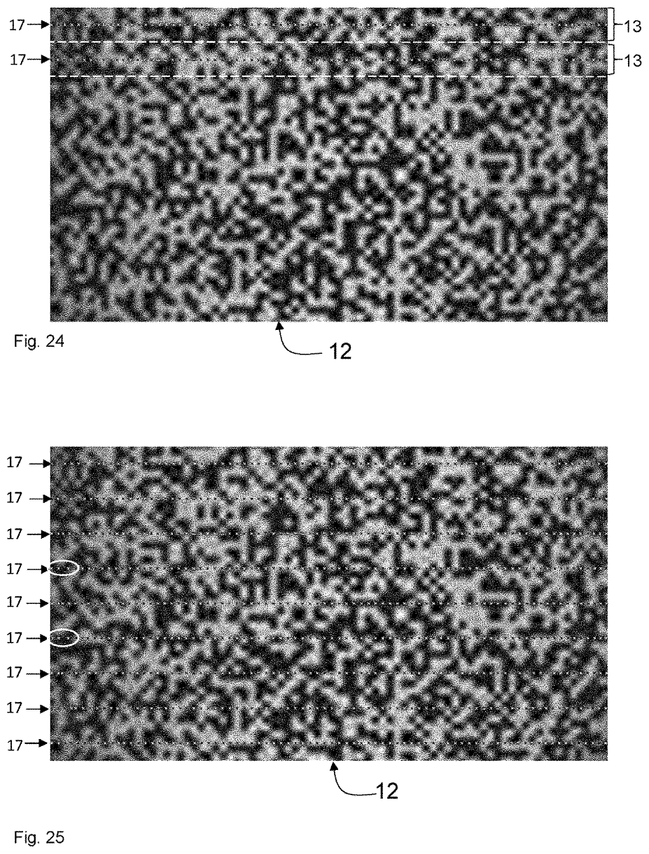

Step 370 involves checking whether the group qₙ just considered was the last group q. If this is not the case, the running variable is incremented in step 380 and steps 320, 330, 340, 350 and 360 are subsequently repeated. FIG. 24 shows the point profile 17 in the row direction for the next window 13 or the second group q₂. FIG. 25 shows the point profile 17 in the complete image 12 in the row direction for all windows 13 or all 9 groups.

Despite the accumulation of neighboring rows, in some cases exactly Nₓ peak values are not detected on all rows, but rather usually fewer. This holds true particularly for systems with invisible data modulation, since very low data amplitudes are used in these systems. It is evident that not all the symbol positions were detected in the case of the 4th and 6th groups. The circled regions in FIG. 25 show that a symbol position is in each case here missing. In other words, 80 symbol positions were ascertained for each of the groups 1-3, 5 and 7-9, but only 79 symbol positions were ascertained for the groups 4 and 6.

Once all q groups have been analyzed, step 300 is ended. A respective vector whose elements indicate block centers in the form of pixel indices is then present for each of the q groups. There is thus a total of q vectors.

It should also be noted that it is expedient to choose the number k_{B} of block rows to be large enough that a transition between different symbol values occurs with high probability between each pair of neighboring block columns in at least one block row of the group. This facilitates the recognition of a symbol transition between neighboring block columns. However, since the symbol positions of neighboring rows have strong correlation or have only slight offsets owing to e.g., lens distortion, fewer pixel rows can also be added in order to reduce the computational complexity. Furthermore, more or fewer than 9 groups or block rows can be taken into account. B_{y} way of example, N_{y} groups/block rows, e.g., 45, can be considered. Furthermore, for example,

$${k}_{P} = ⌈ \frac{{B}_{y} \cdot {N}_{y}}{30} ⌉ = 36$$

neighboring rows can be accumulated (the symbols ┌x┐ represent the so-called ceiling function). That means that in this case the outer pixel rows are each assigned to two groups, i.e., the groups overlap. The number qₙ of groups, the number k_{B} of block rows and the number k_{P} of pixel rows can each be predefined for the method.

An alternative to the course of the method in FIG. 7 is shown in FIG. 7a. Here the complete image 12 is processed in its entirety, instead of the windowed processing.

Firstly, in step 331, the DC component is once again removed by subtraction of the mean value and the application of an even function to the complete image, in particular squaring or absolute value formation, wherein the DC component removal is not effected row by row, but rather for the entire complete image I: (I−Ī)². The DC component There is the mean value of the image, i.e., the sum of all pixel values divided by the number of pixels (Mₓ·M_{y}=1920×1080). The removal of the DC component is not necessary if the starting image 1b is already present without a DC component. The even function is applied pixel by pixel.

Step 341 then involves filtering the squared complete image I in the column direction (vertically) with a transposed vector of ones having k_{P} elements: [1 1 1 . . . 1 1 1]^{T}. This corresponds mathematically to a two-dimensional discrete convolution of the vector of ones with the complete image 12 present in the form of an M_{y}×Mₓ matrix. Analogously to step 340 this brings about a column-by-column addition of k_{P} row values. On the basis of the example of the 1^{st} column (j=1) this means the summation of the row values 1 to k_{P} to form a first value, the summation of the row values 2 to k_{P}+1 to form a second value, the summation of the row values 3 to k_{P}+2 to form a third value, etc. Illustratively, this corresponds to a window moving (vertically) over the complete image in the column direction. As before the value k_{P} can be e.g. 36 or 120.

Bandpass-filtering of the filtered complete image 12 in the row direction (horizontally) is subsequently carried out in step 351. As before, for this purpose it is possible to use a digital finite impulse response filter (FIR filter) having an average frequency of Nₓ/Mₓ=1/Bₓ, e.g. 0.042 line pairs per pixel.

In the bandpass-filtered complete image 12, in step 311, analogously to step 310, along q reference rows distributed uniformly over the image, the signal profile of the complete image 12 is then evaluated in respect of where local maxima/peak values lie. B_{y} way of example, q=9 rows are considered. In step 361, those pixel positions at which the signal Sᵢ(j) of the pixel row i where

$$i = \frac{{M}_{y}}{q} ( {q}_{n} - \frac{1}{2} ) and j = 1 ... {M}_{x}$$

has a local maximum are then determined successively for each reference row. The pixel positions ascertained then correspond to the symbol positions sought. For the first row, the following holds true with qₙ=1 for the previously considered example,

$$i = \frac{1080}{9} ( 1 - \frac{1}{2} ) = 60 ,$$

so that the signal S₆₀(j) of the pixel row 60 is analyzed with regard to local peak values. This is carried out analogously to step 360. Once the pixel positions with local peak values for the row qₙ have been ascertained, the running variable qₙ is incremented in step 381 and the signal Sᵢ(j) of the next row, i.e.

$$i = \frac{1080}{9} ( 2 - \frac{1}{2} ) = 180 ,$$

is examined for the occurrence of local peak values.

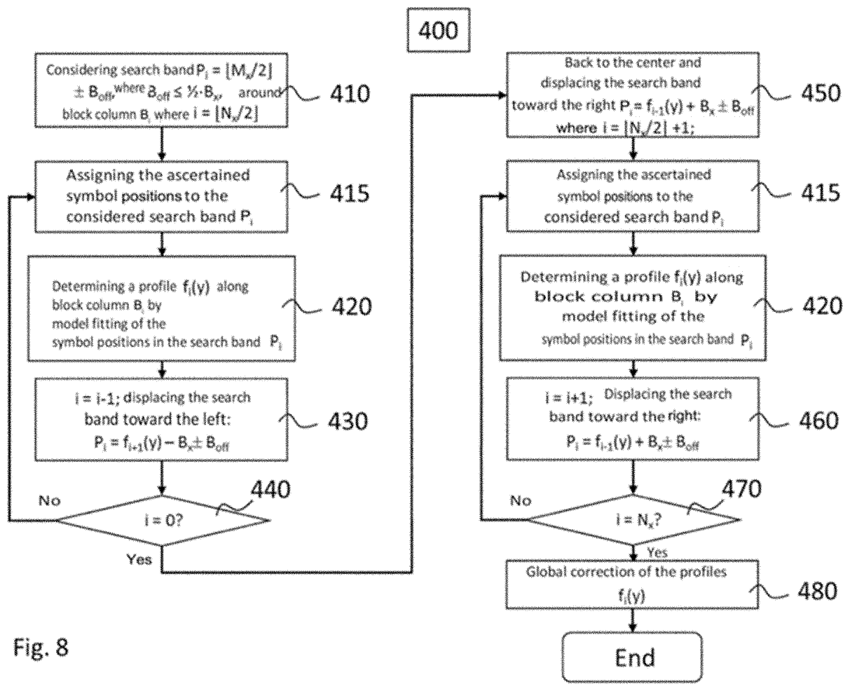

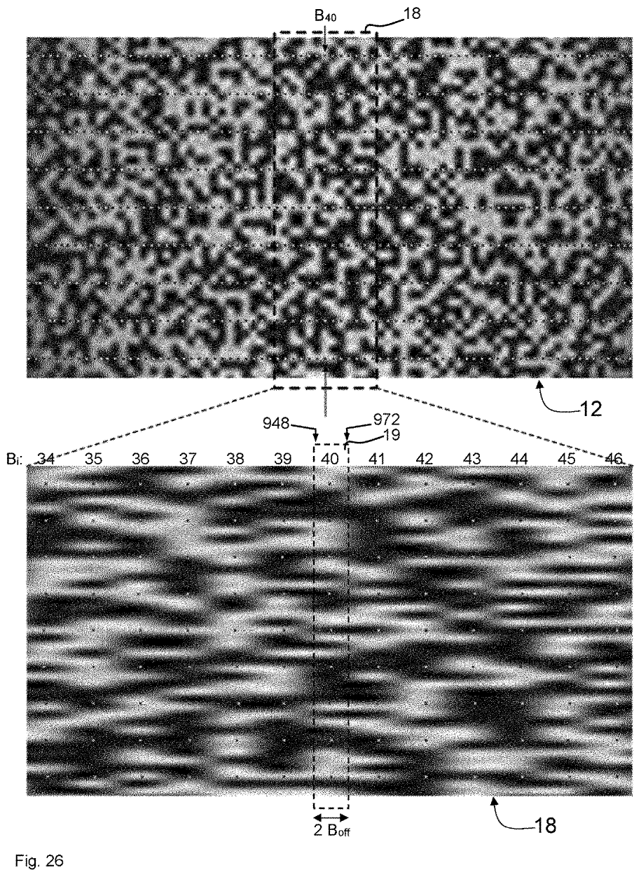

Once all q reference rows or all q groups have been analyzed, see interrogation in step 370 or 371, step 400 involves determining the profile of the symbol series in the direction of the second dimension of the matrix code, i.e., here in the column direction. FIG. 8 concretizes the individual method steps of this method section 400 and FIGS. 26 to 35 elucidate the effects of the individual steps.

The determination of the profile of the symbol series in the column direction begins in the horizontal center of the complete image 12 because the lens distortion is here the least. For this purpose, step 410 involves firstly generally considering an initial search band Pᵢ=└Mₓ/2┘±B_{off}, where B_{off}≤½·Bₓ and i=└Nₓ/2┘, around block column Bᵢ, wherein B_{off} denotes an offset that defines the width of the search band Pᵢ. The other variables are as before:
Mₓ the number of pixel columns of the complete image 12,
Bₓ the width of a data block/symbol of the matrix code 1 in the complete image 12 in pixels, and
Nₓ the number of block columns of the matrix code 1.

Consequently, └Mₓ/2┘ indicates the center of the complete image 12 and └Nₓ/2┘ indicates the center of the matrix code 1 in each case in the direction of the dimension x.

FIG. 26 shows at the top the complete image 12 in accordance with FIG. 25 with a depicted column window 18 in the horizontal image center, which window is illustrated in an enlarged manner at the bottom in FIG. 26. The column window 18 comprises the block columns 34 to 46. In the example considered, the complete image 12 furthermore has Mₓ=1920 pixel columns. Furthermore, the block width Bₓ in the horizontal direction (x-direction, row direction) is still 24 pixel columns and the number Nₓ of block columns of the matrix code is still 80. Consequently, the initial search band Pᵢ and the first block column Bᵢ considered are those with the index i=└80/2┘=40, i.e., P₄₀ and B₄₀. It should be noted, however, that a different block column Bᵢ from the central image region of the complete image 12 can also be used as initial search band Pᵢ or first block column Bᵢ, without departing from the method according to the present invention. In this regard, one of the block columns 35 to 45 could also be used since here, too, the lens distortion is absent or at least minimal.

The initial search band P₄₀, identified by reference numeral 19 in FIG. 26 et seq., is defined around the first block column B₄₀ so that the horizontal center of the search band 19 corresponds to the horizontal center of the block column B₄₀. This is the case for pixel row └Mₓ/2┘=960. Taking account of an offset B_{off} of ½·Bₓ=12 pixel rows on both sides of the center └Mₓ/2┘ means that the initial search band P₄₀ extends between pixel columns 960−B_{off} and 960+B_{off}, and thus lies between pixel columns 948 and 972. In other words, the width of the initial search band P₄₀ corresponds to twice the offset 2B_{off}, i.e., the block width Bₓ in the direction of the first dimension x. In this example, the initial search band P₄₀ thus has a width of 24 pixel columns. This width is maintained for the further search bands Pᵢ.

Step 415 then firstly involves ascertaining which of the peak values/maxima previously ascertained for the individual q groups (FIG. 7) or q rows (FIG. 7a) are assigned to the search band Pᵢ considered, that is to say here firstly to the initial search band P₄₀, i.e., lie within the latter. This cannot simply be done by taking in each case the i-th (└Nₓ/2┘-th) element of the q vectors, in which the pixel indices of the maxima are stored, since it is not provided that all the symbol positions have previously been recognized correctly. In this regard, the i-th element of one of the vectors could also belong to the neighboring column └Nₓ/2┘+1 or even to a different search band 19. Step 415 therefore involves checking or ascertaining for each of the q vectors whether an element of the vector has a value or indicates a pixel index which lies within the search band Pᵢ considered.

In relation to the example considered here, that means ascertaining whether an element of the q vectors indicates a pixel index lying between the pixel columns 948 and 972 and which pixel index this is. It is then assumed by way of example that:
the element 40 of the vector for the first group qₙ=1 indicates the pixel index 958,
the element 40 of the vector for the first group qₙ=2 indicates the pixel index 956,
the element 40 of the vector for the first group qₙ=3 indicates the pixel index 962,
the element 39 of the vector for the first group qₙ=4 indicates the pixel index 960,
the element 40 of the vector for the first group qₙ=5 indicates the pixel index 961,
the element 39 of the vector for the first group qₙ=6 indicates the pixel index 955,
the element 40 of the vector for the first group qₙ=7 indicates the pixel index 958,
the element 40 of the vector for the first group qₙ=8 indicates the pixel index 960, and
the element 40 of the vector for the first group qₙ=9 indicates the pixel index 963.

This is because, as mentioned above with regard to FIG. 25, one symbol position in each case was not recognized for the groups qₙ=4 and qₙ=6 and so the associated vectors contain one element less. It should also be noted that the symbol positions stored in the vectors in the row direction, relative to their position in the column direction, are assumed in each case in the middle of each group qₙ, i.e., for the group qₙ in each case at pixel row i=M_{y}/q(qₙ−½), that is to say at pixel row 60 for q₁=1, pixel row 180 for q₂=2, pixel row 300 for q₃=3, pixel row 420 for q₄=4, pixel row 540 for q₅=5, pixel row 660 for q₆=6, pixel row 780 for q₇=7, pixel row 900 for q₈=8, pixel row 1020 for q₉=9.

Once the symbol positions have been assigned in the form of the pixel indices, step 420 then involves determining a profile fᵢ(y) of the symbol positions along block column Bᵢ by fitting a model, e.g., a 2nd order polynomial, which brings about both interpolation and smoothing of the symbol positions in the search band Pᵢ, that is to say here firstly the profile f₄₀(y) along block column B₄₀ by model fitting of the symbol positions in the search band P₄₀. The variable y indicates the pixel index in the direction of the dimension y. To put this another way, the curve f₄₀(y) is defined as regression on the basis of the coarse symbol positions [i, j]=[60, 958], [180, 956], [300, 962], [420, 960], [540, 961], [660, 955], [780, 958], [900, 960] and [1020, 963]. Model fitting with outlier filtering is known to the person skilled in the art, for example, from Martin A. Fischler & Robert C. Bolles (June 1981), Random Sample Consensus: A Paradigm for Model Fitting with Applications to Image Analysis and Automated Cartography (PDF). Comm. ACM. 24 (6): 381-395.

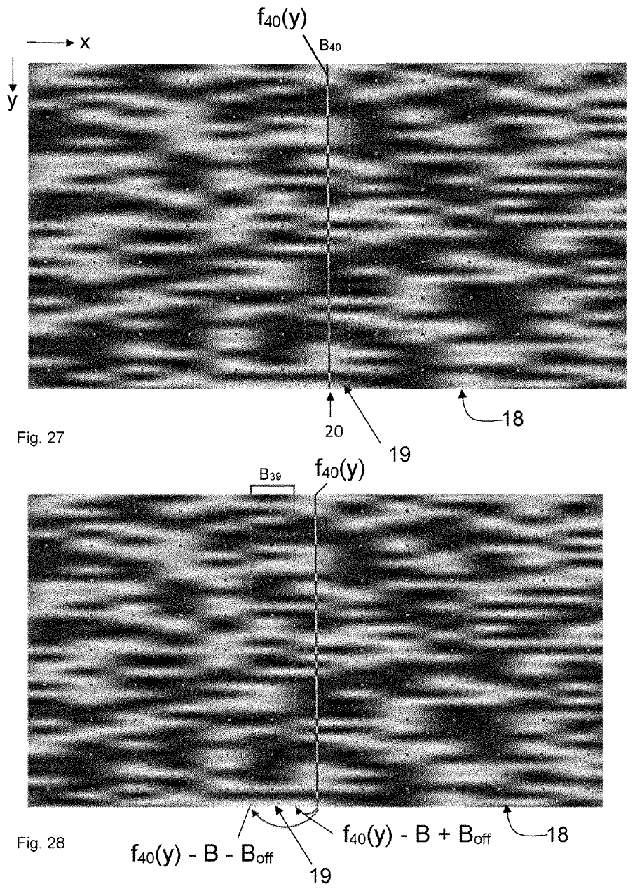

This procedure ascertains the curve profile f₄₀(y) along the first block column B₄₀ in the first search band P₄₀ 19. The curve profile 20 of the symbol positions for the first search band P₄₀ is depicted in FIG. 27. It should be noted that a higher-order polynomial too can, but need not, be used. The complexity of the model depends on the inaccuracies of the simple sampling that are to be compensated for. A second-order polynomial is suitable, for example, for simultaneously compensating for a perspective trapezoid distortion owing to the inaccuracy of the localization of the code area 6 and the lens distortion of the camera. Higher orders can be used for cameras having more severe lens distortion.

The profile fᵢ(y) of the symbol positions along the next block column Bᵢ is then determined. For this purpose, the search band 19 can be displaced toward the right or left. The search band is displaced toward the left in the example in accordance with FIG. 28. Since the origin of the x, y coordinate system used for describing the pixel and block positions is at the top left in accordance with FIGS. 1, 13 and 14, the running variable i is consequently decremented: i=i−1, step 430, and the next search band P₃₉ around block column B₃₉ is considered. However, the previous search band 19, the limits of which were regarded as straight lines for the sake of simplicity, is not purely displaced. Rather, the form of the new search band is oriented to the previously determined curve profile 20 of the symbol positions by virtue of the limits of the new search band P₃₉ resulting from the parallel displacement of the previous profile f₄₀(y) by Bₓ−B_{off} and Bₓ+B_{off}. In this regard, the next search band P₃₉ extends from f₄₀(y)−Bₓ−B_{off} to f₄₀(y)−Bₓ+B_{off}, wherein f₄₀(y)−Bₓ forms the center of the new search band P₃₉. FIG. 28 elucidates this parallel displacement.

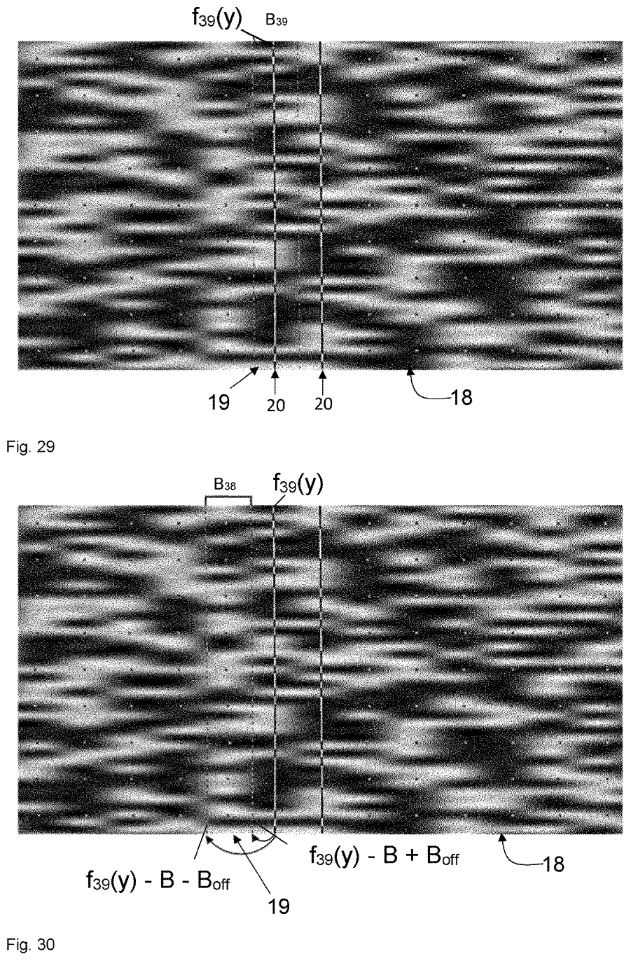

The ascertained symbol positions (pixel indices in the vectors) are then assigned to the new search band P₃₉ analogously to the procedure mentioned above, step 415. This is subsequently followed by determining the profile f₃₉(y) of the symbol positions along block column B₃₉ by way of the above-mentioned model fitting of the symbol positions in the search band P₃₉, step 430. The curve profile 20 of the symbol positions of the second search band P₃₉ is depicted in FIG. 29.

Further decrementing of the running variable i in step 430 causes a further displacement of the search band 19 toward the left, the limits of the new search band P₃₉ again resulting from the parallel displacement of the profile f₃₉(y) of the symbol positions in the previous search band P₃₉ or along the previous block column B₃₉, as elucidated in FIG. 30. This is then followed again by assigning the ascertained symbol positions (pixel indices in the vectors) to the new search band P₃₈ analogously to the procedure mentioned above, step 415, and subsequently determining the profile f₃₈(y) of the symbol positions along block column B₃₈ by way of model fitting of the symbol positions in the new search band P₃₈, step 430.

The determination of the further profiles fᵢ(y) of the symbol positions in the further search bands Pᵢ is continued iteratively, i.e., steps 415, 420 and 430 are repeated for each search band Pᵢ or each block column Bᵢ to the left of the complete image center, i.e. i<└Nₓ/2┘, until the decrementing of the running variable i leads to the value 0. This case is checked for each iteration in step 440. FIG. 31 shows an enlarged excerpt from the complete image 12, consideration being given here to a block column 4 or respectively a search band P₄ which results from the previous symbol profile f₅(y) by way of parallel displacement. The curve profile 20 of the symbol positions for the 37th search band P₄ (block column B₄) is depicted in FIG. 32. For elucidation purposes, the symbol positions are also depicted in this illustration, and so it is readily evident how the curve f₄(y) interpolates and smooths them since they lie sometimes to the right and sometimes to the left of the curve f₄(y). Excerpt A shows that outliers are filtered by the model fitting.

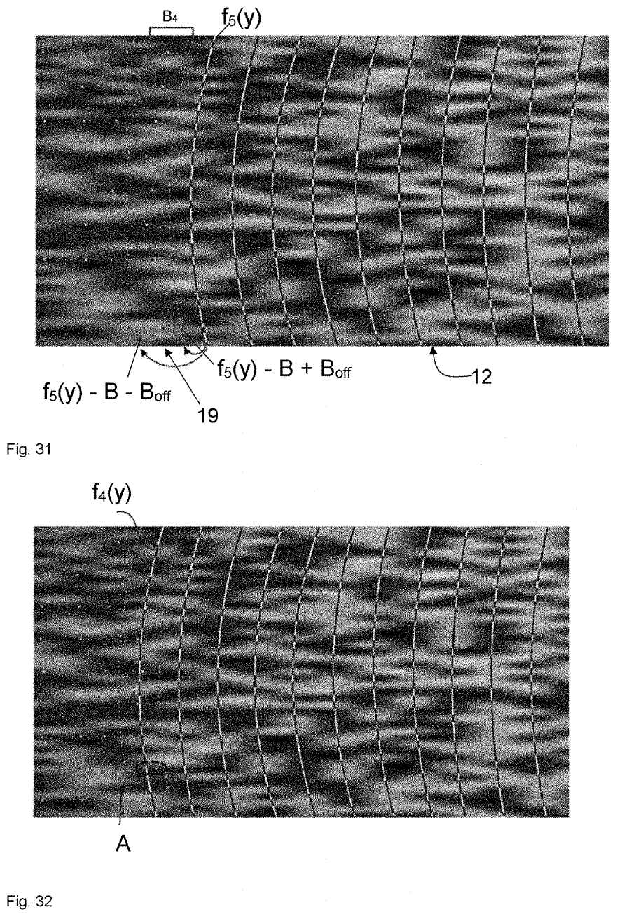

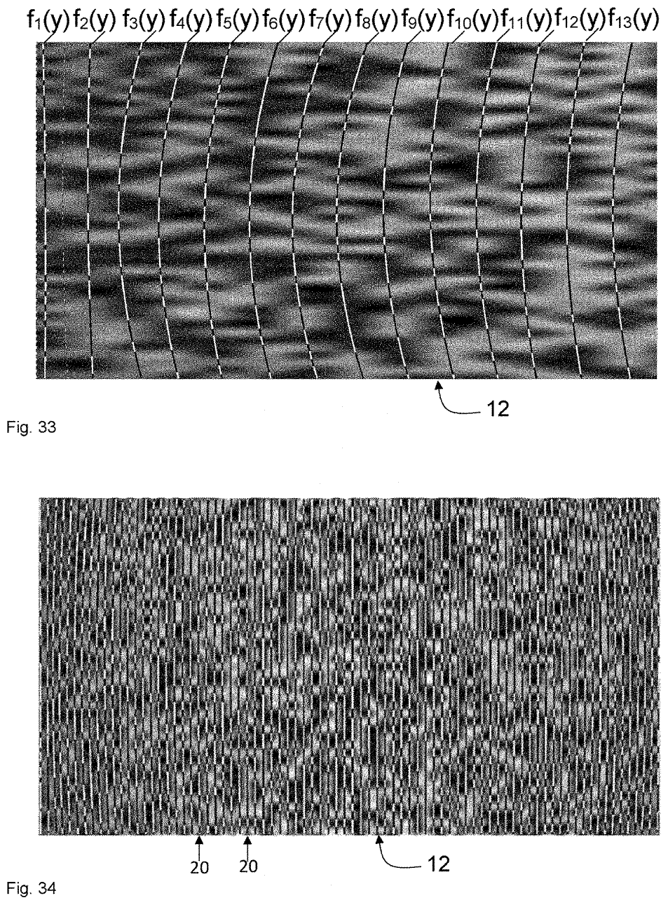

FIG. 33 shows where all symbol profiles fᵢ(y) of the block columns Bᵢ to the left of the complete image center, i.e., for i≤└Nₓ/2┘ are determined. It should be noted that for the case where the parallel displacement of the search band Pᵢ toward the left would have the consequence of negative pixel indices or the pixel index zero, the corresponding search band limit is set to the pixel index 1.

As elucidated in step 440, a running variable i decremented to 0 has the effect that the determination of the profiles of the symbol positions for the left image half of the complete image 12 is ended. It is continued for the block columns Bᵢ to the right of the complete image center, step 450. For this purpose, the running variable is set to i=[Nₓ/2]+1, that is to say that the initial search band P₄₀ of the image center as considered in step 410 is used and is displaced toward the right by one block column Bᵢ. In this case, the limits of this new search band Pᵢ will again be defined from the parallel displacement of the profile f₄₀(y) of the symbol positions that was ascertained in the initial search band P₄₀: Pᵢ=+Bₓ±B_{off} with i=└Nₓ/2┘+1. Continuing the previous example where Nₓ=80 block columns, therefore, the 41^{st} search band P₄₁ around the 41^{st} block column B₄₁ is now considered, the limits of which result from the parallel displacement of the profile f₄₀(y), see FIG. 27, toward the right by the block width Bₓ, i.e., 24 pixel columns, plus-minus an offset B_{off} amounting to half the block width B. To put this another way, the profile f₄₀(y) is displaced toward the right by Bₓ−B_{off} (in this case ½ Bₓ, since B_{off}=½ Bₓ) in order to form the left search band limit and is displaced toward the right by Bₓ+B_{off} (in this case 3/2 Bₓ, since B_{off}=½ Bₓ) in order to form the right search band limit. This method is thus totally complementary to the previously considered left image half of the complete image 12.

In this regard, step 415 involves firstly again ascertaining which symbol positions stored in the vectors are assigned to the search band P₄₁ considered, i.e., lie within the latter. This is subsequently followed by determining the profile f₄₁(y) along block column B₄₁ by way of model fitting of the symbol positions assigned to the search band P₄₁, step 420. The procedure in steps 415 and 420 is identical here to the left image half.

The next search band Pᵢ of the right image half is then considered, step 460. This is effected by incrementing the running variable i, i.e., displacing the last search band Pᵢ toward the right analogously to step 450, so that the next search band is defined by Pᵢ=fᵢ₋₁(y)+Bₓ±B_{off}, i.e. P₄₂=f₄₁(y)+24 pixel rows±12 pixel rows. Steps 415 and 420 are then repeated iteratively for each search band Pᵢ in the right image half of the complete image 12, or respectively for each block column Bᵢ therein, by incrementing the running variable i for each iteration step in step 460 until the total number Nₓ of block columns is reached. This is checked in step 470. If that is the case, then the determination of the profile of the symbol series in the direction of the second dimension of the matrix code 1, here the columns, has inherently ended. FIG. 34 shows the fitted column profiles 20 of all Nₓ block columns B.

The column profiles 20 at the edges of the complete image 12 are conspicuous, however, as is readily discernible from the profiles f₁(y), f₂(y) along the first and second block columns B₁, B₂ in FIG. 33. Since the data blocks in the edge region are cut off in part by the image equalization during the code area detection together with subsequent homographic projection, the detected symbols in these regions have large deviations. Therefore, the column profiles f₁(y), f₂(y) fitted by the model exhibit a different behavior than for example the column profiles f₃(y), f₄(y) of the neighboring columns that are at a further distance with respect to the edge. A global correction of the model parameters over all columns, more precisely a correction of the coefficients of the same order of the polynomials describing the profiles, is expedient at this juncture and is carried out in step 480.

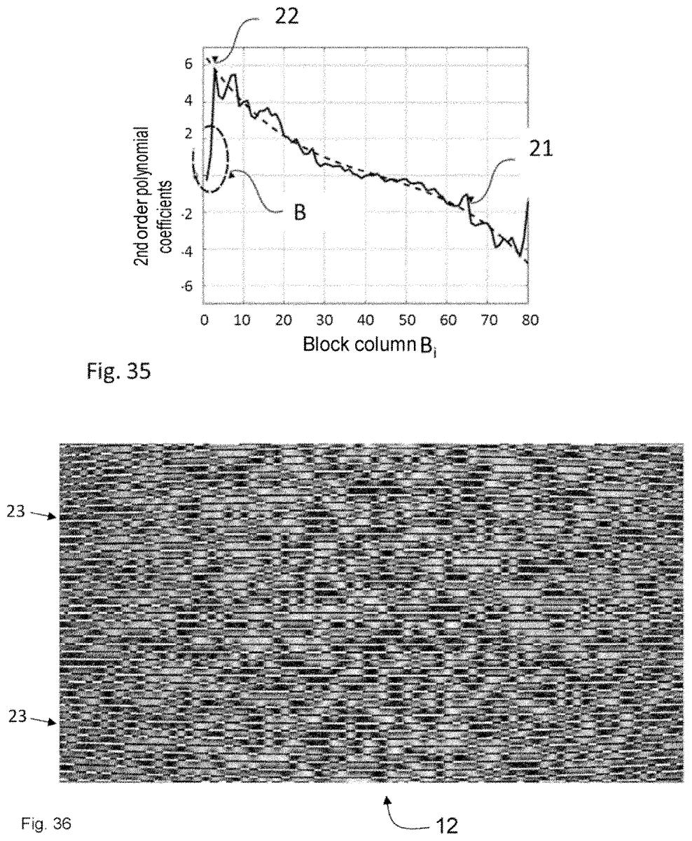

FIG. 35 elucidates the global correction for all second-order coefficients. The diagram therein shows as an example the profile 21 of all second-order polynomial coefficients over the Nₓ=80 block columns. If a polynomial fᵢ(y)=aᵢy²+bᵢy+cᵢ is thus used as a model for the column profiles, then FIG. 35 shows the profile 21 of the iteratively fitted model coefficients aᵢ for i=1 to Nₓ in the form of a solid line. The region B identifies outliers in the case of the block columns 1 and 2. Block column 80 also exhibits an outlier. The global correction is effected by smoothing the profile or further fitting of the coefficients, thus resulting in the dashed continuous curve 22. The errors at the image edge are corrected thereby. A corresponding correction can also be carried out for the 1st and 0th order coefficients. The method section 400 is thus ended.

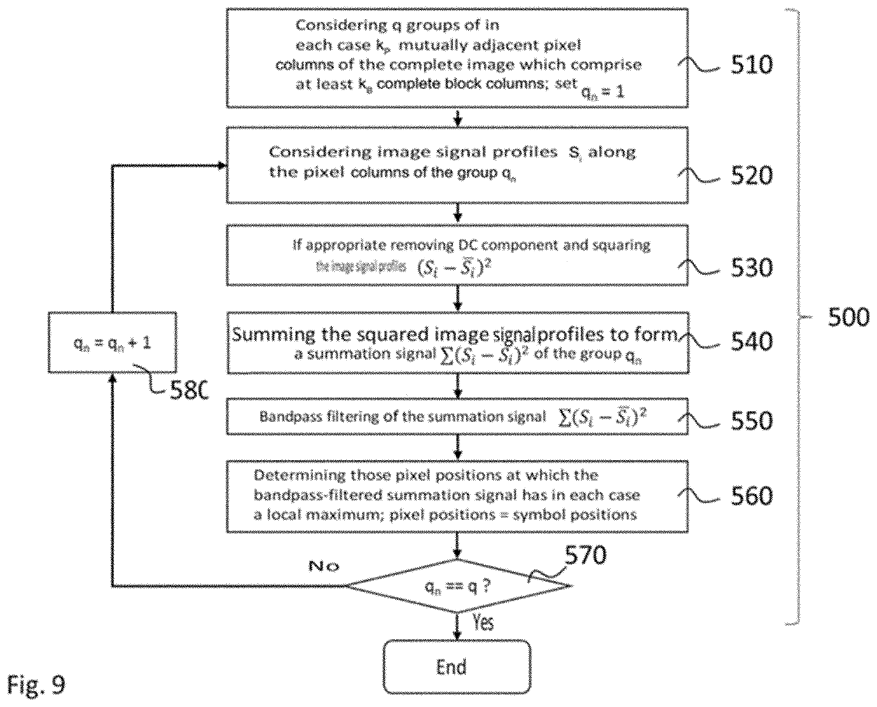

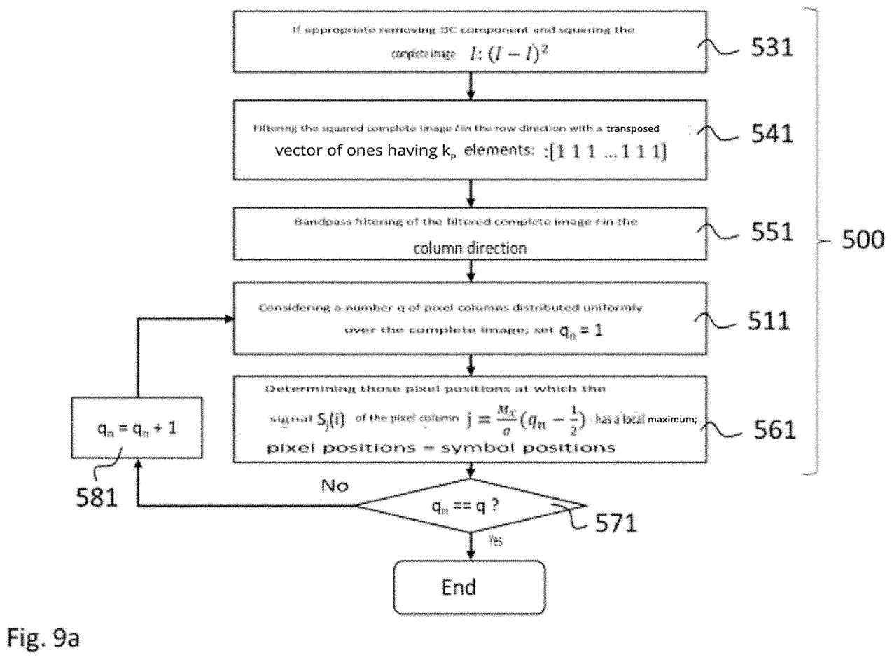

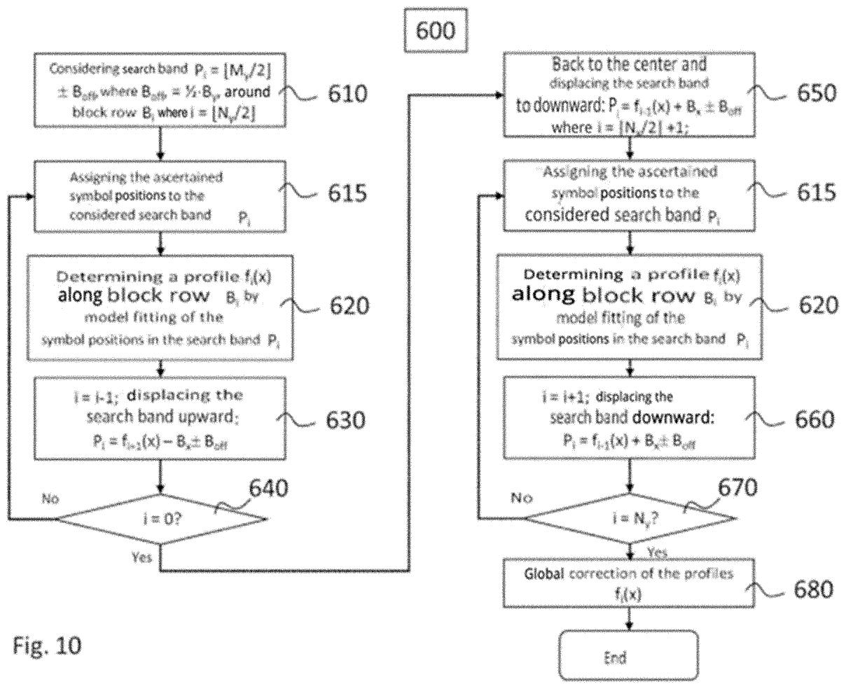

The method sections 300 and 400 are then repeated for the respective other dimension. The individual method steps for this are illustrated in FIGS. 9, 9a and 10.

FIG. 9 shows the method sequence 500 for the coarse detection of the center of the symbol positions along the second dimension of the matrix code, i.e. here along the block columns. In this case, the individual method steps 510 to 580 correspond to method steps 310 to 380 in FIG. 7 apart from the fact that the columns of the matrix code 1 and of the complete image 12 are considered, rather than the rows. In this regard, step 510 involves considering q groups of in each case k_{P} mutually adjacent pixel columns of the complete image 12 which comprise at least k_{B} complete block columns, and setting the running variable qₙ=1. This is subsequently followed by considering image signal profiles Sᵢ along the k_{P} pixel columns of the group qₙ, or the first group qₙ=1 in step 520. In step 530, then if appropriate the DC components in the image signal profiles Sᵢ are removed in each case by subtraction of the mean value, and the mean value-free image signal profiles are squared:(Sᵢ−S̅ₗ)². This step is identical to step 330. Step 540 involves summing the squared image signal profiles to form a summation signal Σ(Sᵢ−S̅ₗ)² of the group qₙ=1, and step 550 involves bandpass filtering of the summation signal Σ(Sᵢ−S̅ₗ)². Step 540 is identical to step 340. Step 550 corresponds to step 350, formally a different center frequency being used for the bandpass filter, namely the average frequency of N_{y}/M_{y}=1/B_{y} (block number/image width=1/block size in dimension y). If square data blocks are used as is here the case, however, the average bandpass filter frequency is identical to that in step 350. Thus, given B_{y}=24 pixels, the average frequency (symbol frequency) is likewise 0.042 line pairs per pixel.

This is subsequently followed by determining those pixel positions at which the bandpass-filtered summation signal has in each case a local maximum/a peak value, the pixel positions forming the symbol positions sought, step 560. This step is identical to step 360. Step 570, which is identical to step 370, involves checking whether the group qₙ just considered was the last group qₙ=q. If not, qₙ is incremented in step 580 analogously to step 380, and steps 520 to 560 are repeated for the next group qₙ of pixel columns. Since method steps 510 to 580 correspond to method steps 310 to 380, reference is made to the explanations concerning FIG. 7.

It should also be noted that the number q of groups of pixel columns in step 510 need not be identical to the number q of groups of pixel rows in step 310. It can be larger or alternatively smaller. However, it is recommended that the number qₙ be oriented to the number of block series of the respective dimension which are intended to be considered in the group. While the example in FIGS. 18, 24 and 25 involved the use of qₙ=9 groups of in each case k_{P}=120 pixel rows for a total of 1080 pixel rows of the complete image 12, e.g., qₙ=16 groups of in each case k_{P}=120 pixel columns for a total of 1920 pixel rows of the complete image 12 can be used in the other dimension in the method section 500.

FIG. 9a shows an alternative method sequence for the coarse detection of the center of the symbol positions along the second dimension of the matrix code, i.e. here along the block columns, analogously to FIG. 7a. In this case, the individual method steps 511 to 581 correspond to method steps 311 to 381 in FIG. 7a apart from the fact that the columns of the matrix code 1 and of the complete image 12 are considered, rather than the rows. Step 531 is identical to step 311. Strictly speaking, this step 531 is not required in the context of the method section 500 because it has already been carried out in step 311. Step 541 corresponds to step 341, but here the squared complete image I is filtered in the row direction with a vector of ones having k_{P} elements: [1 1 1 . . . 1 1 1]. Since the row direction is now involved, the vector of ones is not transposed. Step 551 corresponds to step 351, the bandpass filtering now being carried out in the column direction. The average frequency of the bandpass filter is as in step 550.

Step 511 involves considering a number q of reference columns distributed uniformly over the complete image, and setting qₙ=1, i.e. considering the first reference pixel column. As stated above with regard to the number q of groups, the number q of reference columns in step 511 need not be identical to the number q of reference rows in step 311. It can be larger or alternatively smaller. Along the q reference columns, the signal profile of the complete image 12 is then evaluated in respect of where local maxima/peak values lie. By way of example, q=16 rows are considered. Step 561 then involves determining successively for each reference column those pixel positions at which the signal Sp of the pixel column j where

$$j = \frac{{M}_{y}}{q} ( {q}_{n} - \frac{1}{2} ) and i = 1 ... {M}_{y}$$

has a local maximum. The pixel positions ascertained then correspond to the symbol positions sought. For the first column, the following holds true with qₙ=1 for the example considered previously,

$$j = \frac{1920}{16} ( 1 - \frac{1}{2} ) = 60 ,$$

such that the signal S₆₀(i) of the pixel column 60 is analyzed with regard to local peak values. This is carried out analogously to step 360. Once the pixel positions with local peak values for the column qₙ have been ascertained, the running variable qₙ is incremented in step 581 and the signal Sp of the next column, i.e.

$$j = \frac{1920}{16} ( 2 - \frac{1}{2} ) = 180 ,$$

is examined for the occurrence of local peak values.

Once all q reference columns have been analyzed, see interrogation in step 571, step 600 involves determining the profile of the symbol series in the direction of the first dimension of the matrix code 1, i.e. here in the row direction. FIG. 10 concretizes the individual method steps of this method section 600.

Method steps 610 to 680 in FIG. 10 are identical to the respective method steps 410 to 480 in FIG. 8 apart from the fact that the block column around which the corresponding search band Pᵢ is placed is replaced by the block row and the profiles fᵢ(x) along the individual block rows Bᵢ are determined iteratively on the basis of the symbol positions ascertained in step 560 or 561. A further difference is that proceeding from the vertical center of the complete image 12, where the lens distortion is the least, the complete image 12 is subdivided into an upper and a lower image half. In this case, proceeding from the center └M_{y}/2┘, in the iteratively performed steps 615, 620, 630 and 640 firstly the upper image half is considered, i.e., the row profiles fᵢ(x) where i=1 . . . └N_{y}/2┘ of this upper image half are reconstructed, and subsequently in the iteratively performed steps 615, 620, 660 and 670 the lower image half is considered, i.e. the row profiles fᵢ(x) where i=└N_{y}/2┘+1 . . . N_{y} of this lower image half are reconstructed, this being done by determining or fitting the coefficients of a model for the respective row profile fᵢ(x) in the form of a second-order polynomial in each case by way of interpolation of the symbol positions in the corresponding search band Pᵢ. However, this would also be possible in the opposite order. Finally, in step 680 analogously to step 480 a global correction of the profiles fᵢ(x) is carried out by smoothing the 2nd degree coefficients. In order to avoid repetition, with regard to the individual steps 610 to 680, reference is made to the explanations concerning the respective method steps 410 to 480. FIG. 36 shows the fitted row profiles 23 of all N_{y} block rows Bᵢ.

As can further be gathered from FIG. 6, ascertaining the profile of the symbol series in the direction of the first dimension of the matrix code 1 (step 600) is followed by determining the intersection points of the symbol series profiles, step 700, i.e., the symbol rows and the symbol columns, wherein said intersection points form the 2D sampling points of the sampling grid sought, see FIG. 4 after step 200. The intersection points can be determined for example by equating the models of the curve profiles (polynomials) and solving the resulting system of equations.

Consequently, it is now possible to carry out the sampling of the matrix code 1 in accordance with the sampling grid ascertained, see step 800 in FIG. 4. The individual method steps of this method section 800 are illustrated in FIG. 11. In the case of frontal recordings of the matrix code 1, the sampling can, for example, effected in the starting image 1b or the camera recording 5 since signal-to-noise ratio would be lost in the case of sampling in the complete image 12 owing to its arising from the homographic projection (equalization, interpolation, step 120) and its low-pass filtering (step 130). Consequently, the ascertained sampling grid or its sampling points is/are firstly mapped/projected onto the starting image 1b or the camera recording 5 via an inverse homographic projection (inverse transformation), see step 820, so that each sampling point in the complete image 12 is assigned a corresponding x, y coordinate in the starting image 1b or the camera recording 5. FIG. 38 elucidates the result of this inverse projection. The inverse transformation is the inverse homographic projection from step 120. This is subsequently followed by prefiltering the starting image 1b in step 830, as will also be described below, and sampling the symbols of the matrix code 1 in accordance with the inverse-transformed sampling grid in step 840, which yields corresponding samples.

However, it is also possible and may be expedient to perform the sampling in the complete image 12. Step 820 is omitted in this case. Specifically, if the matrix code 1 is severely distorted in the starting image 1b owing to the recording angle or the perspective of the camera recording (not a frontal recording), which can be established on the basis of the position and shape (trapezoid shape) or the code area 6, sampling in the equalized complete image 12 (trapezoid shape straightened) is more expedient, see step 860, because sampling in the non-equalized starting image 1b would require location-dependent filtering again in order to equalize the matrix code 1 in the starting image 1b. According to the present invention, a decision algorithm can be provided which assesses the position and shape of the code area 6 and decides whether sampling is effected in the starting image 1b or the camera recording 5 or in the complete image 12. The decision algorithm is represented by the block 810 in FIG. 11. In the case of a frontal recording, i.e., the matrix code is not distorted in the starting image 1b (no branch), steps 820, 830 and 840 are performed, i.e., the matrix code 1 is sampled in the starting image 1b. In the case of a greatly perspective recording, i.e., the matrix code is severely distorted in the starting image 1b (yes branch), steps 850 and 860 are performed, i.e., the complete image 12 is prefiltered in step 850 like in step 830 and the matrix code 1 is sampled in the complete image 12 in step 860.

The sampling in step 840 or step 860 can be effected in accordance with the sampling grid previously ascertained in step 700, i.e., at the 2D sampling points. As noted above with regard to this step 700, however, sampling can also be effected so that the matrix code 1 is firstly sampled along the entire symbol series profiles in the direction of one dimension, i.e., in the direction of the entire symbol rows or the entire symbol columns, i.e., at each pixel which lies on these symbol rows or symbol columns. From these sampling series thus formed, subsequently only those values which lie at an intersection point with one of the symbol series profiles in the direction of the other dimension are then used. These selected values are then the sought samples at the intersection points and the previously ascertained samples between two intersection points are discarded again.

As further shown in FIG. 4, in step 900 the samples are subjected to postprocessing and the effect of crosstalk, i.e., the intersymbol interference, is compensated for. In this case, the signal-to-interference-plus-noise ratio (SINR) of the sampled symbols is simultaneously increased. This is done by means of “spatial signal processing,” i.e., processing of the samples of those symbols which are spatially related to one another, more precisely are neighboring, since the values thereof are correlated. According to the literature, the optimum compromise between utilizing the spatial correlation present between neighboring symbols and avoiding same or minimizing the intersymbol interference is a so-called Wiener deconvolution filter, see R. Gonzalez, R. Woods, Digital Image Processing, Prentice Hall, 2002, pp. 262-266. However, the parameterization of this filter necessitates precise estimations of the noise spectrum and the channel response, which cannot be reliably inferred from the camera recording 5, in particular owing to the location-dependent quality of the data blocks in the camera recording 5. A two-stage approach is instead pursued in which firstly the starting image 1b, or the complete image 12 in the case of a greatly perspective recording, is preprocessed with a suitably dimensioned prefilter in step 830 or 850, and a further compensation of the intersymbol interference on the basis of the properties of the samples is subsequently performed after the sampling.

In order to avoid a loss of signal quality as a result of artificially produced correlations, the avoidance of intersymbol interference is taken into account as a criterion as early as in the prefiltering in step 830 or 850. For this purpose, a modified matched filter is used as a prefilter for step 830 or 850. This filter largely corresponds to a matched filter, but differs therefrom by virtue of an approximately 20% narrower spatial dimensioning compared with an unmodified matched filter. A matched filter for one-dimensional signals is described in J. Proakis and M. Salehi, Digital Communications, 5th expanded ed., McGraw-Hill, 2007, pp. 178-182. Since the block structure of matrix codes can usually be modelled by rectangular pulses in the spatial dimensions, a matched filter can be defined spatially separately by the impulse responses:

$${h}_{x} ( x ) = \{ \begin{matrix}\frac{1}{{B}_{x}} , & x \leq \frac{{B}_{x}}{2} \\ 0 , & x > \frac{{B}_{x}}{2}\end{matrix}$$

$$and$$

$${h}_{y} ( y ) = \{ \begin{matrix}\frac{1}{{B}_{y}} , & x \leq \frac{{B}_{y}}{2} \\ 0 , & x > \frac{{B}_{y}}{2}\end{matrix}$$

In this case, the block sizes Bₓ and B_{y} should be scaled, if appropriate, to the starting image 1b in step 850. The modification is effected by scaling the spatial extent of these impulse responses by a factor

$$\frac{1}{{W}_{b}} .$$

This results in the following modified impulse responses:

$${h}_{x} ( x ) = \{ \begin{matrix}\frac{{W}_{b}}{{B}_{x}} , & x \leq \frac{{B}_{x}}{2 {W}_{b}} \\ 0 , & x > \frac{{B}_{x}}{2 {W}_{b}}\end{matrix}$$

$${h}_{y} ( y ) = \{ \begin{matrix}\frac{{W}_{b}}{{B}_{y}} , & x \leq \frac{{B}_{y}}{2 {W}_{b}} \\ 0 , & x > \frac{{B}_{y}}{2 {W}_{b}}\end{matrix}$$

As a result of this spatial reduction, the edge regions of the blocks, in which intersymbol interference is dominant, are not taken into account during sampling in the block center. While optimally dimensioned Wiener deconvolution filters have a greater SINR, this filter concept is significantly more robust vis-à-vis variations of the parameters of noise and channel distortion.

After the sampling, the spatial intersymbol interference is compensated for by equalization filtering being carried out (equalizer) on the basis of the correlation properties of the sampled signal. The method steps specifically performed for this purpose are illustrated in FIG. 12. They implement step 900 in FIG. 4. It is assumed here that the neighboring symbols are statistically independent of one another. That means that the autocorrelation function of the data signal (freed of a mean value) becomes negligibly small upon displacement by one symbol (or a plurality thereof). However, the low-pass filter characteristic of the camera lens leads to symbol crosstalk, thus resulting in the superposition of the information from neighboring blocks and the production of correlations between the symbols. As a result of the limited width of said low-pass filter characteristic, the correlations with the horizontal and the vertical neighboring blocks are of particular relevance at this point.

In general it is sufficient to carry out the compensation of the intersymbol interference globally for the entire sampled symbols. In the case of severe lens distortions or perspective distortions, a location-dependent compensation may achieve more accurate results. For the case of global compensation, five matrices M₀, M₁, M₂, M₃, M₄ are firstly defined within the sampled symbols as follows:
M₀ includes all samples/symbols from row 2 to row N_{y}−1 and column 2 to column Nₓ−1, i.e., all samples of symbols which do not lie on the edge;
M₁ includes the samples/symbols from row 2 to row N_{y}−1 and column 1 to column Nₓ−2, i.e., displaced by one column toward the left with respect to M₀;
M₂ includes the samples/symbols from row 2 to row N_{y}−1 and column 3 to column Nₓ, i.e., displaced by one column toward the right with respect to M₀;
M₃ includes the samples/symbols from row 1 to row N_{y}−2 and column 2 to column Nₓ−1, i.e., displaced by one row upward with respect to M₀; and
M₄ includes the samples/symbols from row 3 to row N_{y} and column 2 to column Nₓ−1, i.e., displaced by one row downward with respect to M₀.

This is carried out in step 910 in FIG. 12. Subsequently, in step 920, four correlation coefficients r₁, r₂, r₃, r₄ are calculated by:

$$corr ( {M}_{a} , {M}_{b} ) = \frac{{\sum }_{i} {\sum }_{j} ( {M}_{a , ij} - \overline{{M}_{a}} ) ( {M}_{b , ij} - \overline{{M}_{b}} )}{\sqrt{( {\sum }_{i} {\sum }_{j} {( {M}_{a , ij} - \overline{{M}_{a}} )}^{2} ) ( {\sum }_{i} {\sum }_{j} {( {M}_{b , ij} - \overline{{M}_{b}} )}^{2} )}}$$

r₁=corr(M₀,M₁)

r₂=corr(M₀,M₂)

r₃=corr(M₀,M₃)

r₄=corr(M₀,M₄)

On the basis thereof, in step 930, a two-dimensional digital filter is defined as follows:

$${F}_{ISI} = [ \begin{matrix}0 & - {r}_{3} & 0 \\ - {r}_{1} & 1 + {r}_{1} + {r}_{2} + {r}_{3} + {r}_{4} & - {r}_{2} \\ 0 & - {r}_{4} & 0\end{matrix} ]$$

By applying this filter to the sampled symbol matrix in step 940, it is possible largely to remove the correlation between symbols and hence the spatial intersymbol interference.

As further shown in FIG. 4, the symbol values filtered in this way are subsequently demodulated to form a bitstream in a conventional manner, step 1000, which bitstream is then decoded in step 1100. The method is thus ended.

In summary, the present invention is innovative in the following features:
Separation of a two-dimensional problem of the reconstruction of the sampling points into two one-dimensional problems by separately detecting the symbol positions on the rows and columns of the data grid and calculating the final sampling points on the basis thereof.
Accumulation over neighboring rows/columns in order to utilize spatial correlation of the symbol positions and increase the probability of occurrence of symbol transitions on account of the statistical independence of the data.
Progressive assignment of the detected symbol positions of the rows/columns, which are possibly not complete. Carrying out the assignment from the center of the data grid step by step toward edges in order to utilize the spatial dependence of the lens distortion of the camera.
Fitting a high-order (e.g., second-order) model in each case for the assigned symbol positions for robust reconstruction of sampling curves taking account of the lens distortion of the camera and the perspective distortion owing to inaccurate localization of the data region.
Utilization of the fitted model of the neighboring column/row for determining the center positions of the current assignment, wherein the spatial correlation of the symbol positions or of the lens distortion of the camera is utilized in order to increase the robustness of the assignment of the detected symbol positions.
Use of a filter whose spatial extent is reduced compared with the matched filter, as a result of which a high SINR can be attained without precise information about the channel behavior.
Determination of a two-dimensional discrete filter for subsequent reduction of the spatial intersymbol interference after sampling by removal of the correlation of the neighboring symbols.

The present invention affords a solution for the reconstruction of the sampling points for two-dimensional matrix codes in particular having high information density, with no additional synchronization patterns being required. In comparison with the pattern-based methods, the method of this present invention affords the following advantages:
Robustness of the detection: in the case of the pattern-based methods, the symbol positions are estimated on the basis of the synchronization patterns detected in the code. In this case, the robustness of the pattern detection is crucial because an unsuccessful attempt (e.g., an undetected or incorrectly detected pattern) can lead to immediate failure of the sampling point detection. However, robust detection of the synchronization patterns is non-trivial in many cases: a similar pattern composed of an unfavorable combination of data blocks in the vicinity of the actual pattern, damage to the synchronization patterns owing to e.g., a dirty display, undesired partial concealment of the data grid during recording or low data amplitudes e.g., in the case of the concealed transfer concepts can cause incorrect detection. In the patternless method of the present invention, in contrast thereto, the soft information of the entire data grid is utilized, as a result of which the instability of the pattern detection under unfavorable conditions can be avoided. Since in this method the neighboring rows and columns are accumulated and the spatial correlation is utilized, the sampling points are reconstructable as long as there is a sufficient signal component in the recording.
Accuracy of the sampling points: the accuracy of the sampling points in the case of the pattern-based methods depends exclusively on comparatively a small number of synchronization patterns. In this case, the deviation of the localization from synchronization patterns propagates in the determination of the symbol positions. Furthermore, in this case, the sampling points are linearly interpolated on the basis of the synchronization patterns, the lens distortion of the camera not being compensated for. This can cause severe deviations of the sampling points particularly in the case of high-density matrix codes. By contrast, in the case of the method of the present invention, the entire data symbols are used for determining the symbol positions. The deviations of the sampling points can therefore be minimized by virtue of the significantly greater amount of information. Furthermore, the lens distortion of the camera is compensated for by model fitting, with no need for camera calibration in advance. As a result, the accuracy of the sampling points is considerably increased, particularly for cameras of smartphones, for example, which have comparatively severe distortion and normally are not calibrated by manufacturers sufficiently precisely for technical applications. Furthermore, the fitted models of the sampling points can support the future reconstructions as a starting point.
Occupancy of the data capacity: in order to provide a sufficient accuracy of the sampling points particularly for high-density matrix codes, in the case of the pattern-based methods a non-negligible proportion of the data capacity is occupied by the synchronization patterns. The proportion is typically approximately 5%, but may also be significantly higher such as, e.g., up to 14% in the case of a data matrix code. Since no additional synchronization patterns need be added in the case of the method of the present invention, for an identical code dimension it is possible to transfer more data or to achieve stronger error protection and hence more robust transfer.

The present invention also provides a method for reducing the spatial intersymbol interference for matrix codes having high information density. Through the use of prefiltering that is robust vis-à-vis parameter variations and the measurement of correlation coefficients in the sampled data grid, it is possible to minimize the complexity of a direct estimation of the channel properties. It is found on the basis of experimental results that the symbol errors can be considerably reduced by virtue of this processing particularly in the case of high-density matrix codes with small data amplitudes (e.g., in the case of the concealed transfer concepts such as DaVid with a data block size of 4×4 UHD pixels, see the technical publication: Xu, J., Klein, J., Brauers, C., Kays, R., Transmitter design and synchronization concepts for DaViD display camera communication, 2019 28th Wireless and Optical Communications Conference, WOCC 2019—Proceedings). As a result, the block size of the matrix code can be further reduced and higher data rates can be achieved.

The individual method constituents are highlighted once again below:
1. Method for detecting the symbol positions of a two-dimensional matrix code recorded by a camera.
2. Separation of a two-dimensional problem of the reconstruction of the sampling points into two one-dimensional problems by separately detecting the symbol positions on the rows and columns of the data grid and calculating the final sampling points on the basis thereof. For the individual detections, methods are used which are based on 1D methods known from the literature but have modifications (see point 4) in which the two-dimensional structure is utilized.
3. Generation of a set of one-dimensional signals by interpolation of the two-dimensional image signal along a row/column structure to which the code area roughly corresponds and which initially need not match the row/column structure of the code.
4. Computation of the information from neighboring rows/columns which is processed in a 1D synchronizer, e.g., by way of windowed summation of the nonlinear distorted row/column profiles using the squaring method for 1D synchronization, for increasing the probability of occurrence of symbol transitions on account of the statistical independence of the data. The spatial correlation of the symbol positions is utilized in this case.
5. Iterative reconstruction of the profile of the columns/rows from the symbol positions by parameterizing a model (see point 7) on the basis of the symbols arranged in a column/row (see points 6 and 8).
6. Estimation of a starting column/row, e.g., in the image center, where the camera distortion is generally the least, as a starting point for the progressive symbol allocation.
7. Parameterization of a model for the column/row profile, e.g., third-order polynomial, thus utilization of the fact that the camera distortion over the entire image spatially changes only slowly, and of the spatial dependence of the symbol positions.
8. Search for symbol positions in the direct neighborhood of an already reconstructed column/row. The center of the search region for the new column/row is determined by extrapolation proceeding from the already known neighboring column/row by an estimated block size. Continuation of the model parameterization and search until all column/row profiles have been reconstructed.
9. Optional global correction e.g., by model fitting or filtering of the profile of the model parameters of all columns/rows over the entire image. (Optional)
10. During sequential processing of the two dimensions, it is possible for the column/row profiles reconstructed from the dimension processed first to be utilized as extrinsic information for the processing (see point 3) of the other dimension. (Optional)
11. Determination of the spatial coordinates and the row/column association of each symbol/data block e.g., by calculation of the intersection points of the previously reconstructed column/row profiles.
12. Sampling of the data blocks with two-stage spatial reception filtering (see points 13 and 14) on the basis of the coordinates determined in point 11.
13. Filtering at the image level before sampling by means of a filter whose spatial extent is reduced compared with the matched filter, as a result of which a high SINR can be achieved without precise information about the channel behavior despite the extended impulse response of a camera recording having limited sharpness.
14. Filtering at the sampling point level for subsequent compensation of the spatial intersymbol interference after sampling of the data blocks. The filter coefficients are derived e.g. from the correlation coefficients averaged over the image, since the undistorted data pattern can be assumed to be spatially uncorrelated.

The present invention is not limited to embodiments described herein; reference should be had to the appended claims.

What is claimed is:

1-15. (canceled)

16: A method for evaluating a two-dimensional matrix code comprising symbol series which are arranged in rows and columns, wherein the two-dimensional matrix code is set forth in a complete image comprising pixel series which are arranged in rows and columns, individual symbol series profiles are reconstructed on a basis of the complete image, and samples are ascertained at intersection points of the individual symbol series profiles, the method comprising:
in a first step, ascertaining an approximate position of symbols along the symbol series in a direction of a first dimension of the complete image successively,
for a number q of groups of k_{P} mutually adjacent pixel series in the direction of the first dimension via a procedure in which, for each of the number q of the groups of kₚ,
an even function is applied to DC component-free signal profiles along the individual pixel series in the direction of the first dimension so as to process the DC component-free signal profiles, and then
summing the DC component-free signal profiles which have been processed to form a summation signal, wherein the summation signal is subjected to a bandpass filtering and pixel positions are ascertained at which a bandpass-filtered summation signal has in each case a local maximum,
or
for a number q of pixel series distributed over the complete image in the direction of the first dimension by a procedure in which,
an even function is applied to a DC component-free complete image so as to process the DC component-free complete image,
filtering the DC component-free complete image which has been processed in a direction of a second dimension with a transposed vector of ones having k_{P} elements, and then
subjecting the DC component-free complete image which has been processed and filtered to a bandpass filtering in the direction of the first dimension so as to ascertain, in a q pixel series, those pixel positions at which a bandpass-filtered signal along a respective pixel series has in each case a local maximum,
wherein the ascertained pixel positions are used as a position of the symbols in the direction of the first dimension;
in a second step, ascertaining the individual symbol series profiles along an other dimension of the complete image successively via a procedure in which a search band is defined for each of the individual symbol series along the other dimension and ascertained symbol positions which lie within a corresponding search band are firstly ascertained, wherein for each of the individual symbol series profiles along the other dimension, a mathematical model of a curve describing the corresponding profile is fitted so that the curve interpolates and smooths the ascertained symbol positions within the respective corresponding search band;
in a third step, repeating the first step for the other dimension in order to ascertain an approximate position of the symbols along the symbol series in a direction of the other dimension; and
in a fourth step, repeating the second step for the first dimension in order to ascertain the individual symbol series profiles along the first dimension of the complete image.

17: The method as recited in claim 16, wherein the even function which is applied in the first step is a squaring value formation or an absolute value formation.

18: The method as recited in claim 16, wherein, before ascertaining the approximate position of the symbols, the method further comprises:
ascertaining an image area occupied by the two-dimensional matrix code in a starting image which is formed by a camera recording or was obtained from camera recordings,
wherein,
the image area is mapped onto the complete image via a homographic projection.

19: The method as recited in claim 18, wherein,
the homographic projection in an inverse homographic projection, and
via the inverse homographic projection, a sampling grid is mapped back onto the starting image and the matrix code is there sampled.

20: The method as recited in claim 18, further comprising:
filtering the starting image before the sampling using a modified matched filter so as to obtain impulse responses; and
scaling impulse responses by a factor in a spatial direction compared with an unmodified matched filter.

21: The method as recited in claim 20, wherein the factor is
$$\frac{1}{{1.2}^{′}} .$$

22: The method as recited in claim 16, wherein, before ascertaining the approximate position of the symbols, the method further comprises:
subjecting the complete image to a low-pass filtering.

23: The method as recited in claim 16, wherein, by ascertaining the intersection points of the individual symbol series profiles, the method comprises:
determining a grid of sampling points; and then
sampling the two-dimensional matrix code at the sampling points.

24: The method as recited in claim 16, wherein, before applying the even function in the first step, the method further comprises:
removing a DC component from the signal profiles along individual pixel series,
wherein,
the DC component is the DC component of the respective signal profile or of the entire complete image (12).

25: The method as recited in claim 16, wherein a center of the complete image is used as a start for a first search band.

26: The method as recited in claim 25, wherein, limits of a second search band and each further search band are defined by a parallel displacement of a profile of the symbol series which was ascertained for a previous search band.

27: The method as recited in claim 16, wherein the bandpass filtering is effected by a digital filter with an average frequency which substantially corresponds to a quotient of a number of the symbols and a number of the pixels in a direction of a dimension considered.

28: The method as recited in claim 16, wherein the model is a 2nd order polynomial or a 3rd order polynomial.

29: The method as recited in claim 16, further comprising;
at least one of,
after the second step, globally correcting the individual symbol series profiles along the other dimension of the complete image, and
after the fourth step, globally correcting the individual symbol series profiles along the first dimension of the complete image,
via a procedure in which coefficients of a respective mathematical model describing the individual symbol series profiles along a respective dimension are fitted so that coefficients of a same order lie on a continuous curve.

30: The method as recited in claim 16, wherein, after a sampling for compensation of spatial intersymbol interference, the method further comprises:
subjecting the samples to an equalization filtering via a two-dimensional digital filter F_{ISI}, the coefficients of which are ascertained from a correlation of the samples.

31: The method as recited in claim 30, wherein the two dimensional digital filter digital filter F_{ISI} is of the form:
$${F}_{ISI} = [ \begin{matrix}0 & - {r}_{3} & 0 \\ - {r}_{1} & 1 + {r}_{1} + {r}_{2} + {r}_{3} + {r}_{4} & - {r}_{2} \\ 0 & - {r}_{4} & 0\end{matrix} ]$$
in which r₁, r₂, r₃, r₄ are correlation coefficients which are calculated according to the formula:
$$corr ( {M}_{a} , {M}_{b} ) = \frac{{\sum }_{i} {\sum }_{j} ( {M}_{a , ij} - \overline{{M}_{a}} ) ( {M}_{b , ij} - \overline{{M}_{b}} )}{\sqrt{( {\sum }_{i} {\sum }_{j} {( {M}_{a , ij} - \overline{{M}_{a}} )}^{2} ) ( {\sum }_{i} {\sum }_{j} {( {M}_{b , ij} - \overline{{M}_{b}} )}^{2} )}}$$
r₁=corr(M₀,M₁)
r₂=corr(M₀,M₂)
r₃=corr(M₀,M₃)
r₄=corr(M₀,M₄),
wherein M₀, M₁, M₂, M₃, M₄ is in each case a matrix within which the samples are defined as follows:
M₀ includes the samples of row 2 to row N_{y}−1 and column 2 to column Nₓ−1 of the matrix code,
M₁ includes the samples of row 2 to row N_{y}−1 and column 1 to column Nₓ−2 of the matrix code,
M₂ includes the samples of row 2 to row N_{y}−1 and column 3 to column Nₓ of the matrix code,
M₃ includes the samples of row 1 to row N_{y}−2 and column 2 to column Nₓ−1 of the matrix code, and
M₄ includes the samples of row 3 to row N_{y} and column 2 to column Nₓ−1 of the matrix code,
wherein Nₓ is a number of columns of the matrix code and N_{y} is a number of rows of the matrix code.

32: A reader for evaluating a two-dimensional matrix code comprising symbol series arranged in rows and columns, wherein the reader it is configured to carry out the method as recited in claim 16.

33: A software application for a reader, wherein
the reader is configured to evaluate a two-dimensional matrix code comprising symbol series arranged in rows and columns pursuant to the method as recited in claim 16, and
the software application comprises instructions for carrying out the method as recited in claim 16 when executed on the reader.
